(19) United States
(12) Patent Application Publication
(10) Pub. No.: US 2018/0096595 A1
(43) Pub. Date: Apr. 5, 2018

(54) Traffic Control Systems and Methods

(71) Applicant: Street Simplified, LLC, Central Point, OR (US)

(72) Inventors: Andrew William Janzen, Altadena, CA (US); Ryan McKay Monroe, Los Angeles, CA (US)

(73) Assignee: Street Simplified, LLC, Central Point, OR (US)

(21) Appl. No.: 15/725,200

(22) Filed: Oct. 4, 2017

Related U.S. Application Data
(60) Provisional application No. 62/404,146, filed on Oct. 4, 2016.

(51) Int. Cl. G08G 1/04; G08G 1/07; G06K 9/00; G06K 9/62; G06K 9/20

(52) U.S. Cl. CPC G08G 1/04; G08G 1/07; G06K 9/209; G06K 9/6267; G06K 9/00973; G06K 9/0063

(57) ABSTRACT

Traffic signal control systems and methods in accordance with various embodiments of the invention are disclosed. One embodiment includes: at least one image sensor mounted with a bird's eye view of an intersection; memory containing a traffic optimization application and classifier parameters for a plurality of classifiers, where each classifier is configured to detect a different class of object; a processing system. In addition, the traffic optimization application directs the processing system to: capture image data using the at least one image sensor; search for pedestrians and vehicles visible within the captured image data by performing a plurality of classification processes based upon the classifier parameters for each of the plurality of classifiers; determine modifications to the traffic signal phasing based upon detection of at least one of a pedestrian or a vehicle; and send traffic signal phasing instructions to a traffic controller directing modification to the traffic signal phasing.

### CROSS-REFERENCE TO RELATED APPLICATIONS

The current application claims priority to U.S. Provisional Application Ser. No. 62/404,146 entitled “Systems and Methods for Improving Traffic Flow and Safety and Systems and Methods for Optimization using Data Extracted via Computer Vision from Sensors” to Janzen et al., filed Oct. 4, 2016, the disclosure of which is incorporated herein by reference.

### FIELD OF THE INVENTION

The present invention relates generally to the direct or indirect control of traffic signals and more specifically to the use of computer vision as a means to inform decisions regarding the switching of traffic signals.

### BACKGROUND

Most modern traffic controllers operate traffic lights in “cycles”, where opposite directions of travel are serviced in sequence. Some “smart” controllers use ancillary information for enhanced performance: magnetic loop sensors are commonly used to directly actuate lights during times of light traffic, detecting the presence or absence of a vehicle in a small region. Camera and RADAR systems have also been developed which mimic the outputs of magnetic loop sensors, by providing actuation to the controller when a vehicle approaches and enters one of the virtual “magnetic loop-style” zones. “Smart” controllers typically use this information to either adjust the fraction of service provided to each direction of travel, or to adjust the light timing in an “ad-hoc”, but still limited, sense.

Sensor systems currently in use also lack many features which are important in dense urban environments. Magnetic loop sensors cannot reliably detect bicycles and motorcycles. Pedestrian sensors are not aware of the real-time presence or position of pedestrians (especially in crosswalks), resulting in inefficient crossing signal timings: too long crossing times delay traffic, whereas timings which are too short leave pedestrians stranded in the intersection, in the face of potentially oncoming traffic. In urban environments with a significant bike population, most traffic lights are optimized for car traffic, requiring bicycles to stop and start more often than necessary.

### SUMMARY OF THE INVENTION

Systems and methods in accordance with many embodiments of the invention utilize computer vision to detect the presence of vehicles, cyclists, and/or pedestrians at an intersection and utilize information concerning presence and/or velocity to control switching of traffic signals. Several embodiments of the invention involve optimization of some parameter using in depth data extracted via computer vision from a camera or other imaging sensor. In another embodiment, a computer vision and optimization system is used to enhance safety and reduce wait times at intersections. The computer vision techniques are generally applicable to many sensor modalities any of which form possible implementations of this invention. The two most common sensors for these techniques are optical and infrared cameras. Although other sensors such as radar, or wireless sensors can be used in conjunction with various embodiments of the present invention sensors are primarily referred to as cameras due to this being the most common. In many embodiments of the invention, the system performs two main processes: a computer vision process for identifying and classifying objects within a scene—typically vehicles, pedestrians, and bicycles; and second a process for making optimized decisions based on that information. The processes although mentioned with respect to traffic can be used to optimize a large class of problems based on some optimization criterion and sufficient information.

One embodiment of the invention includes: at least one image sensor mounted with a bird's eye view of an intersection; memory containing a traffic optimization application and classifier parameters for a plurality of classifiers, where each classifier is configured to detect a different class of object; a processing system; and a traffic controller interface. In addition, the traffic optimization application directs the processing system to: capture image data using the at least one image sensor; search for pedestrians and vehicles visible within the captured image data by performing a plurality of classification processes based upon the classifier parameters for each of the plurality of classifiers; retrieve traffic signal phasing information via the traffic controller interface; determine modifications to the traffic signal phasing based upon detection of at least one of a pedestrian or a vehicle; and send traffic signal phasing instructions to the traffic controller directing modification to the traffic signal phasing.

A further embodiment also includes a network interface.

In another embodiment, the traffic optimization application directs the processor to retrieve information concerning vehicles approaching an intersection via the network interface and to utilize the information to determine modifications to the traffic signal phasing.

In a still further embodiment, the traffic optimization application directs the processor to retrieve information concerning vehicles approaching an intersection via the network interface from at least one service selected from the group consisting of: a traffic control server system; a public transit fleet management system; a second traffic optimization system; an emergency service fleet management system; and a navigation service server system.

In still another embodiment, the traffic optimization application directs the processing system to search for objects visible within the captured image data by performing a plurality of classification processes based upon the classifier parameters for each of the plurality of classifiers in which a determination is made whether to search for objects in a particular pixel location within the captured image data based upon an image prior.

In a yet further embodiment, the image prior is automatically determined based upon a reference image containing a known real-world location of at least one background object visible in the captured image data.

In yet another embodiment, the image prior specifies a minimum size for a particular pixel location within the captured image data; and the traffic optimization application directs the processing system to constrain the search for objects visible within the captured image data at the particular pixel location to objects of the minimum size.

In a further embodiment again, the image prior specifies a maximum size for a particular pixel location within the captured image data; and the traffic optimization application directs the processing system to constrain the search for objects visible within the captured image data at the particular pixel location to objects of below the maximum size.

In another embodiment again, the image prior specifies a minimum size and a maximum size for a particular pixel location within the captured image data; and the traffic optimization application directs the processing system to constrain the search for objects visible within the captured image data at the particular pixel location to objects having a size between the minimum size and the maximum size.

In a further additional embodiment, the processing system comprises at least one CPU and at least one GPU; and the traffic optimization application directs the processing system to search for objects visible within the captured image data by performing a plurality of classification processes based upon the classifier parameters for each of the plurality of classifiers by: directing the GPU to detect features within the captured image data; and directing the CPU to detect objects based upon features generated by the GPU.

In another additional embodiment, at least one of the plurality of classification processes utilizes a random forest classifier that detects objects based upon features detected by the GPU; and the traffic optimization application directs the CPU to terminate a process that utilizes a random forest classifier with respect to a specific pixel location within the captured image data when a specific early termination criterion is satisfied.

In a still yet further embodiment, the CPU comprises multiple processing cores; and the traffic optimization application directs the processing system to execute each of the plurality of classification processes on a separate processing core.

In still yet another embodiment, the at least one image sensor comprises an image sensor that captures color image data.

In a still further embodiment again, the at least one image sensor further comprises an image sensor that captures near-infrared image data.

In still another embodiment again, the at least one image sensor further comprises an image sensor that captures both color image data and near-infrared image data.

In a still further additional embodiment, the at least one image sensor comprises a near-infrared image sensor that captures near-infrared image data.

In still another additional embodiment, the at least one image sensor comprises at least two image sensors that form a multiview stereo camera array that capture images of a scene from different viewpoints.

In a yet further embodiment again, the traffic optimization application directs the processing system to generate depth information by measuring disparity observed between image data captured by cameras in the multiview stereo camera array.

Yet another embodiment again also includes at least one sensor selected from the group consisting of a radar, a microphone, a microphone array, a depth sensor, a magnetic loop sensor, fiber optic vibration sensors, and LIDAR systems.

In a yet further additional embodiment, the traffic optimization application directs the processing system to identify a vehicle.

In yet another addition embodiment, the traffic optimization application directs the processing system to match an identified vehicle against a previously identified vehicle.

In a further additional embodiment again, the traffic optimization application directs the processing system to identify a series of illuminations of a portion of a vehicle indicative of a turn signal.

In another additional embodiment again, the traffic optimization application further directs the processing system to: search for pedestrians, cyclists and vehicles visible within the captured image data by performing a plurality of classification processes based upon the classifier parameters for each of the plurality of classifiers; and determine modifications to the traffic signal phasing based upon detection of at least one of a pedestrian, a cyclist or a vehicle.

Another further embodiment of the invention includes: a plurality of image sensors each mounted with a bird's eye view of an intersection, wherein the plurality of image sensors comprises: a camera capable of capturing color image data; and a near-infrared image sensor that captures near-infrared image data; at least one microphone that captures audio data; memory containing a traffic optimization application and classifier parameters for a plurality of classifiers, where each classifier is configured to detect a different class of object; a processing system; a traffic controller interface; and a network interface. In addition, the traffic optimization application directs the processing system to: capture image data using the plurality of image sensors and audio data using the at least one microphone; search for pedestrians and vehicles visible within the captured image data by performing a plurality of classification processes based upon the classifier parameters for each of the plurality of classifiers; detect the presence of emergency vehicles based upon the captured audio data by performing a classification process based upon classifier parameters for an emergency vehicle classifier; retrieve traffic signal phasing information via the traffic controller interface; determine modifications to the traffic signal phasing based upon detection of at least one of a pedestrian, a vehicle, or an emergency vehicle; send traffic signal phasing instructions to the traffic controller directing modification to the traffic signal phasing; and send information describing detection of at least one of a pedestrian, a vehicle, or an emergency vehicle to a remote traffic control server via the network interface.

Still another further embodiment includes a plurality of traffic optimization systems. In addition, at least one of the traffic optimization systems includes: at least one image sensor mounted with a bird's eye view of an intersection; memory containing a traffic optimization application and classifier parameters for a plurality of classifiers, where each classifier is configured to detect a different class of object; a processing system; a traffic controller interface; a network interface. Furthermore, the traffic optimization application directs the processing system to: capture image data using the at least one image sensor; search for pedestrians and vehicles visible within the captured image data by performing a plurality of classification processes based upon the classifier parameters for each of the plurality of classifiers; retrieve traffic signal phasing information via the traffic controller interface; retrieve information concerning vehicles approaching an intersection via the network interface; determine modifications to the traffic signal phasing based upon at least one factor selected from the group consisting of: detection of a pedestrian, detection of a vehicle, and retrieved information concerning vehicles approaching the intersection; send traffic signal phasing instructions to the traffic controller directing modification to the traffic signal phasing; and send information describing detection of at least one of a pedestrian or a vehicle to a remote traffic control server system via the network interface. Additionally, the traffic control server system includes: a network interface; memory containing a traffic control server system application; and a processing system directed by the traffic control server system application to: receive information describing detection of at least one of a pedestrian, or a vehicle from a traffic optimization system; and transmit information concerning vehicles approaching a given intersection to a traffic optimization system.

### BRIEF DESCRIPTION OF THE DRAWINGS

FIG. 1 conceptually illustrates a traffic control system in accordance with an embodiment of the invention.

FIG. 2 is an image captured by a camera mounted to a traffic signal pole with a bird's eye view of an intersection in accordance with an embodiment of the invention.

FIG. 3A is a conceptual block diagram outlining an embodiment of the invention.

FIGS. 3B-3D are conceptual block diagrams outlining several approaches for sensor inputs and how those are connected to the traffic controller.

FIG. 4 is a flow chart illustrating a process for controlling traffic signal phasing based upon objects detected by a traffic optimization system.

FIGS. 5A and 5B are images captured from a bird's eye view of an intersection. FIG. 5A shows objects detected by a traffic optimization system including false positives. FIG. 5B shows objects detected using a prior that determines regions likely to contain objects and/or types of objects likely to be observed in particular regions.

FIG. 6A is a flow chart illustrating a process for performing intent prediction in accordance with an embodiment of the invention.

FIG. 6B is a flow chart of a process that can be performed by a traffic optimization unit in accordance with an embodiment of the invention.

FIG. 7A is a block diagram illustrating components of a traffic optimization system in accordance with an embodiment of the invention.

FIG. 7B is a flow chart illustrating several sensor methods which can be used in connection with the current invention. Any imaging based sensor is considered a camera in this document.

FIG. 8 is a flow chart illustrating a method for extracting useful data from sensor inputs. Features such as those shown can be implemented on a number of processors with varying storage and data transmission requirements.

FIG. 9 is a flow chart showing some of the statistics which can be generated from the object data.

FIG. 10 is a flow chart showing possible priority options for different types of cars, bikes, and/or pedestrians.

FIG. 11 is a flow chart of how to identify road maintenance issues using footage.

FIG. 12 is a flow chart of how to predict several common hazardous road conditions based on properties of the footage.

FIG. 13 is flow chart showing a process for leveraging footage information to enforce driving regulations.

FIG. 14 is a flow chart showing the iterative process used to accurately read license plates. As many cars are partially occluded, shaded, or over exposed to sunlight, it can be difficult to read the license plate of each car in every frame. This approach combined with image stacking of license plate images can improve the detection accuracy.

### DETAILED DESCRIPTION

Turning now to the drawings, traffic signal control systems and methods in accordance with various embodiments of the invention are illustrated. Traffic signal control systems in accordance with many embodiments of the invention incorporate a plurality of traffic optimization systems located at a network of intersections. Each traffic optimization system can include at least one camera mounted at, near, or on one or more traffic signal poles located at an intersection. One or more sensor processing units within the traffic optimization system can process images captured by the one or more cameras to detect any of a variety of objects including (but not limited to) automobiles (with varying degrees of specificity), busses, cyclists, pedestrians, emergency vehicles, boats, and/or trolleys/light rail trains. In a number of embodiments, the traffic optimization system also detects historical motion of a detected object and/or attempts to predict future motion of the detected object. In this way, the traffic optimization system can determine movement of detected objects such as (but not limited to) vehicles and/or pedestrians with respect to an intersection and can control the traffic signals accordingly. For example, the traffic optimization system can send a message to a traffic signal controller to delay traffic signal phasing based upon the presence of pedestrians within the crosswalk and/or the absence of cars stopped waiting at the intersection. As can readily be appreciated, the specific manner in which the traffic optimization system can communicate with a traffic controller to adjust phasing of traffic signals at an intersection is largely dependent upon the requirements of a given application.

In many embodiments, the traffic optimization system includes a network interface and can exchange data with other traffic optimization systems and/or a remote traffic signal control server system. In a number of embodiments, a traffic signal control server system distributes commands related to traffic signal phasing to individual traffic optimization systems based upon real time data aggregated from the plurality of traffic optimization systems to improve traffic flow through an entire network of intersections. In certain embodiments, the traffic signal control server system can access additional data concerning vehicle locations and/or motion via application programming interfaces (APIs) with services that share vehicle data such as (but not limited) to navigation and/or mapping services. In this way, navigation services can share data cooperatively with the traffic signal control server system to enable the traffic signal control server system to modify signal phasing. In several embodiments, the traffic signal control server system supports an API that enables mapping and/or navigation services to retrieve real time data concerning traffic signal phasing and to modify navigation in accordance with predicted traffic signal phasing at intersections traversed by specific routes. As can readily be appreciated, traffic signal control server systems in accordance with various embodiments of the invention can draw upon a variety of real time and historic data to determine modifications to traffic signal phasing that can be communicated to traffic optimization systems at specific intersections as appropriate to the requirements of a given application including (but not limited to) integrating with public transit server systems, emergency service dispatch systems and/or large scale emergency response/evacuation systems.

In certain embodiments, the traffic optimization system utilizes a sensor processing unit that is configured to efficiently process video data in real time from one or more cameras. In several embodiments, the one or more cameras are mounted with a bird's eye view. The objects likely to be present within different regions within the bird's eye view are relatively constrained. In many embodiments, classifiers are utilized that can detect objects at a range of distances. Computational efficiency improvements can be achieved by using knowledge of the likely distance of an object observed at a particular pixel location to constrain the classifier to look for objects of sizes appropriate to the location. In this way, the classifier does not search for unrealistically small objects at pixel locations corresponding to distances close to the camera and does not search for unrealistically large objects at pixel locations corresponding to distances further from the camera. Accordingly, pixels in images captured by a bird's eye view camera of an intersection are known to be likely to correspond to either a background pixel at a particular distance from the camera or an object that occludes the background pixel. As noted above, the objects that can occlude the background are constrained to a minimum and maximum size based on the physical geometry of the intersection and the physical size of objects. Therefore, using knowledge of the physical geometry of the camera and intersection, obtained for instance using a transform onto one or more images of known geometry, using features of the image with known size scales or learned from the image using the size of objects present in different regions of the pixel space over time, predictions can be made concerning the distance and size of an object that can occlude a particular background pixel location. In this way, searches for objects at each pixel location during classification can be constrained to avoid searching for objects with sizes that fall outside a minimum and/or maximum object size constraint. In several embodiments, a random forest classifier is utilized and the processor can simply skip processing decision trees within the random forest that correspond to object sizes that do not meet the relevant object size constraints at a given pixel location. As can readily be appreciated, any of a variety of classifiers can be utilized to perform object detection as appropriate to the requirements of a given application including (but not limited to) convolutional neural networks and/or a combination of different types of classifiers.

In several embodiments, the traffic optimization system can include additional types of sensors including (but not limited to) microphones, microphone arrays, depth sensors, magnetic loop sensors, network-connected devices, LIDARs and/or RADARs. In a number of embodiments, these sensors can provide detailed information concerning the distance to detected objects (which can be utilized to reduce computation during classification in the manner described above). In addition, audio information can be utilized to determine the presence, location, and/or heading of Emergency Vehicles (EVs). In certain embodiments, information concerning the motion of emergency vehicles can be utilized by traffic optimization systems and/or traffic signal control server systems to control phasing of traffic signals to smoothly preempt traffic signal phasing and provide safe passage to emergency vehicles. In a number of embodiments, information concerning emergency vehicle location is accessed by a traffic signal control server system via an API and/or broadcast by emergency service vehicles via WiFi, Bluetooth, and/or any other wireless communication technology that enables the traffic signal control system to determine the location and/or motion of the emergency vehicles. As can readily be appreciated, the specific sensors utilized within a given traffic optimization system largely depend upon the requirements of a given application.

Traffic signal control systems, traffic signal control server systems, traffic optimization systems, and methods for controlling the phasing of traffic signals to improve traffic flow in accordance with various embodiments of the invention are discussed further below.

### Traffic Signal Control Systems

Traffic control systems in accordance with many embodiments of the invention include one or more traffic optimization systems located at intersections. At least one of the traffic optimization systems includes a camera mounted in a bird's eye view configuration to capture images of vehicles and/or pedestrians approaching and/or exiting the intersection. In several embodiments, the traffic optimization system includes a sensor processing unit that is capable of performing processing including (but not limited to) computer vision processes to detect and/or track vehicles and/or pedestrians approaching, exiting, and/or within the intersection. As discussed below, traffic control systems in accordance with various embodiments of the invention can utilize this data and/or additional data contained within the captured images to perform a variety of functions including (but not limited to) controlling the phasing of traffic signals in an intersection to improve traffic flow. Furthermore, traffic control server systems in accordance with several embodiments of the invention can play a coordinating role aggregating information across a plurality of traffic optimization systems and providing information concerning anticipated traffic flows toward a particular intersection and/or directions concerning modification of traffic signal phasing at specific intersections.

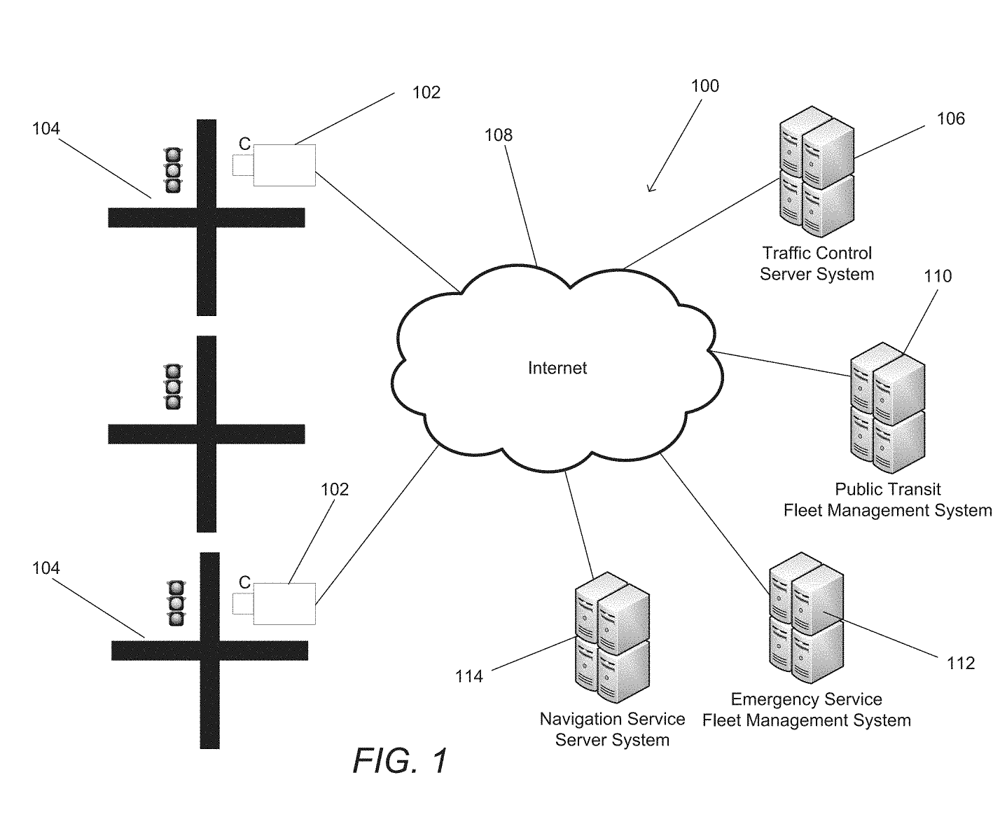

A traffic control system in accordance with an embodiment of the invention is conceptually illustrated in FIG. 1. The traffic control system 100 includes a plurality of traffic optimization systems 102 located at a number of intersections 104. In the illustrated embodiment, the traffic optimization systems 102 communicate with a traffic control server system 106 via a secure network connection over the Internet 108. In many embodiments, the traffic optimization systems 102 communicate with a traffic control server system via a private network including wired and/or wireless communication infrastructure. As noted above, the traffic control server system 106 can play a coordinating role exchanging messages with the traffic optimization systems 102.

In several embodiments, the traffic control server system 106 can also obtain information from a number of additional sources of information. In the illustrated embodiment, the traffic control server system 106 is capable of communicating with a public transit fleet management system 110 to obtain location information concerning a fleet of public transit vehicles, an emergency service fleet management system 112 to obtain location information concerning a fleet of emergency service vehicles, and a navigation service server system 114 to obtain location information concerning a number of vehicles registered with the navigation service. As can readily be appreciated, the specific services from which a traffic control server system 106 can source information is largely only limited by the requirements of a given application.

As is discussed further below, each traffic optimization system 102 can utilize information concerning detected objects approaching and/or within an intersection to provide messages to traffic signal controllers to modify signal timing. In certain embodiments, these messages are relayed via a remote server system including (but not limited to) the traffic control server system 106. In many embodiments, the traffic control server system 106 utilizes information obtained from sources including (but not limited to) the various sources identified above to provide information and/or directions to the traffic optimization systems 102 to facilitate the control of traffic signal phasing.

The ability to share information between traffic optimization systems at different intersections means that individual traffic optimization systems can be robust to individual sensor failures. Data obtained at other intersections can be utilized to predict the likely number of vehicles approaching an intersection and traffic signal phase adjustments can be made accordingly. Furthermore, images captured using bird's eye view cameras can also be utilized to detect vehicles leaving an intersection and this data can be utilized to infer the number of vehicles approaching an intersection for the purposes of controlling traffic signal phase. In several embodiments, a sparse collection of traffic optimization systems can be utilized to connect data from which traffic flows throughout an entire network can be inferred and utilized to control traffic signal phasing at intersections that are not equipped with traffic optimization systems including cameras. As can readily be appreciated, information captured by traffic optimization systems and shared via remote traffic control server systems can be utilized to collect any of a variety of data that can be utilized to improve traffic flow and/or improve public safety as appropriate to the requirements of a specific application.

Systems for implementing traffic optimization systems and traffic control systems and methods for controlling traffic phasing using information concerning detected objects approaching and/or within an intersection in accordance with various embodiments of the invention are discussed further below.

### Traffic Optimization Systems

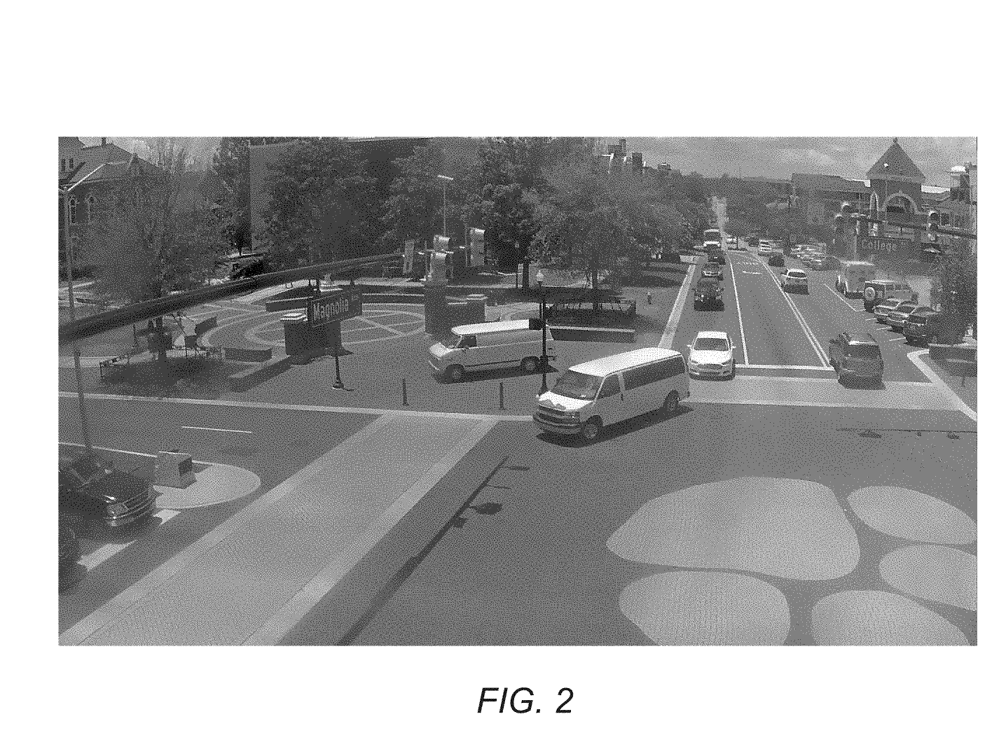

Traffic optimization systems in accordance with several embodiments of the invention include one or more cameras mounted to or near traffic signal poles with a bird's eye views of an intersection. The camera is typically mounted so that the bird's eye view includes a portion of the intersection and a road that enters the intersection. An image captured by a camera in such a configuration is shown in FIG. 2. As is discussed further below, the camera captures images at video frame rates that can be processed in real time by a sensor processing unit. The sensor processing unit can be dedicated to a specific camera and/or additional sensors that provide additional sources of data relevant to the view of the specific camera. In a number of embodiments, the sensor processing unit processes data captured by all sensors associated with a specific intersection. In this way, processing by the sensor processing unit is super-real time in the sense that it may need to process four or more video feeds in real time.

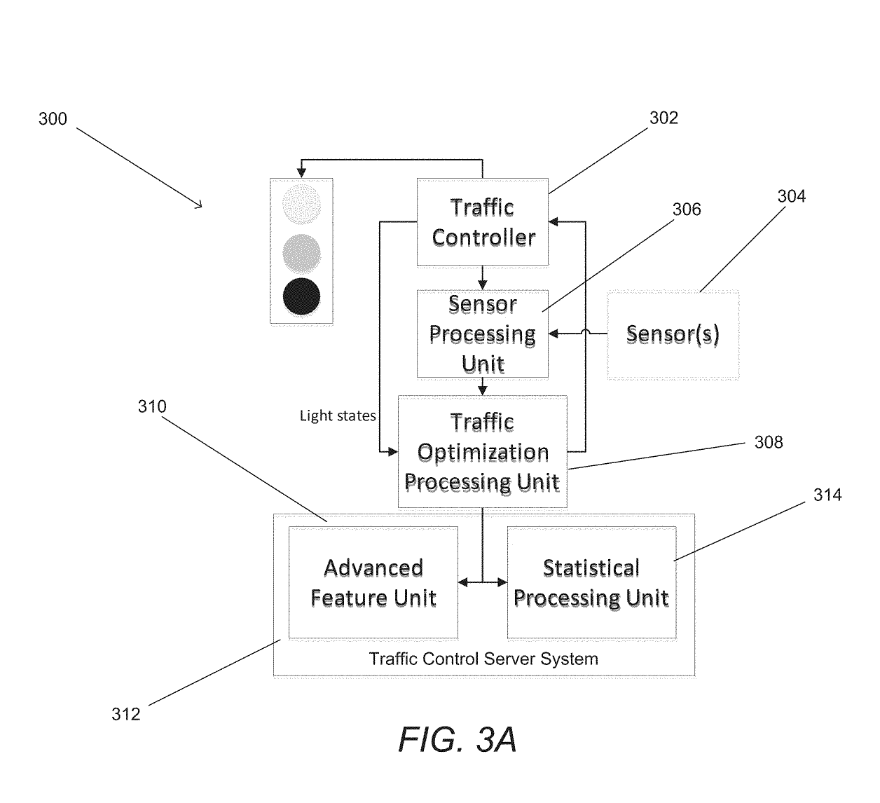

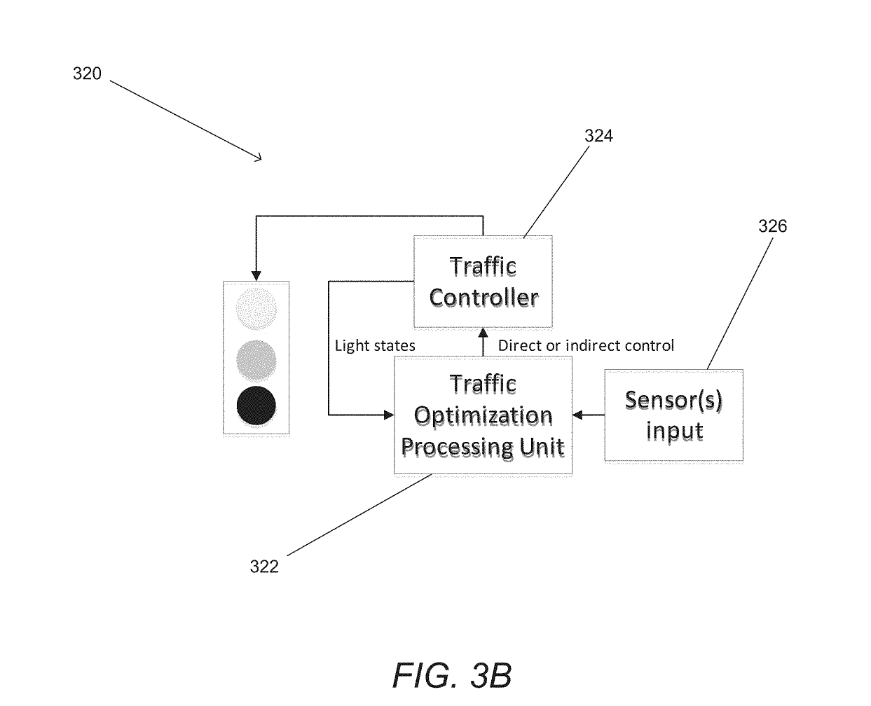

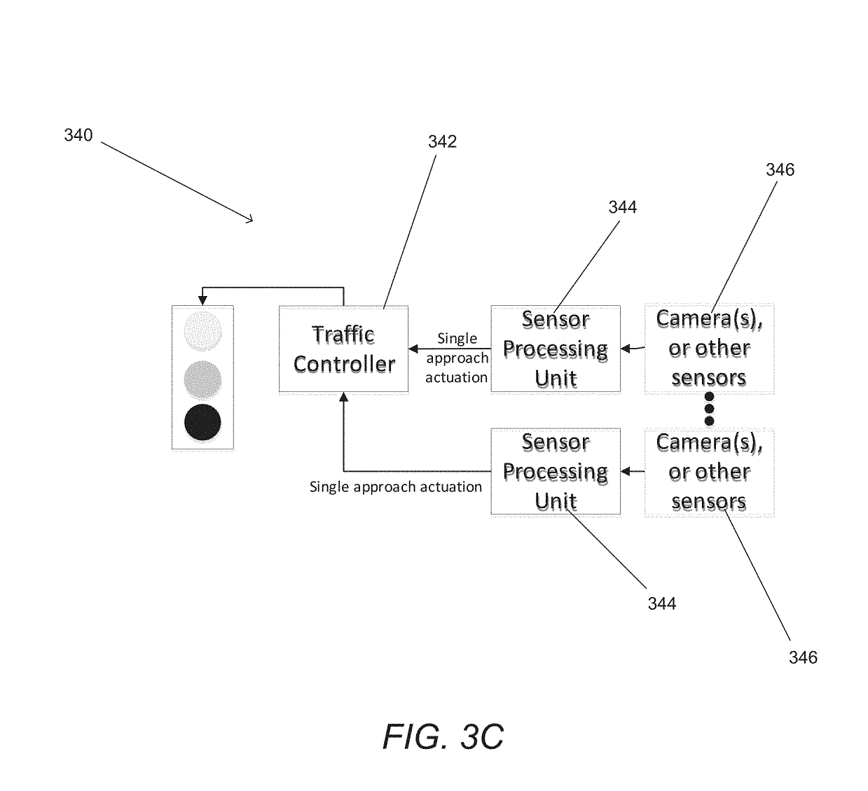

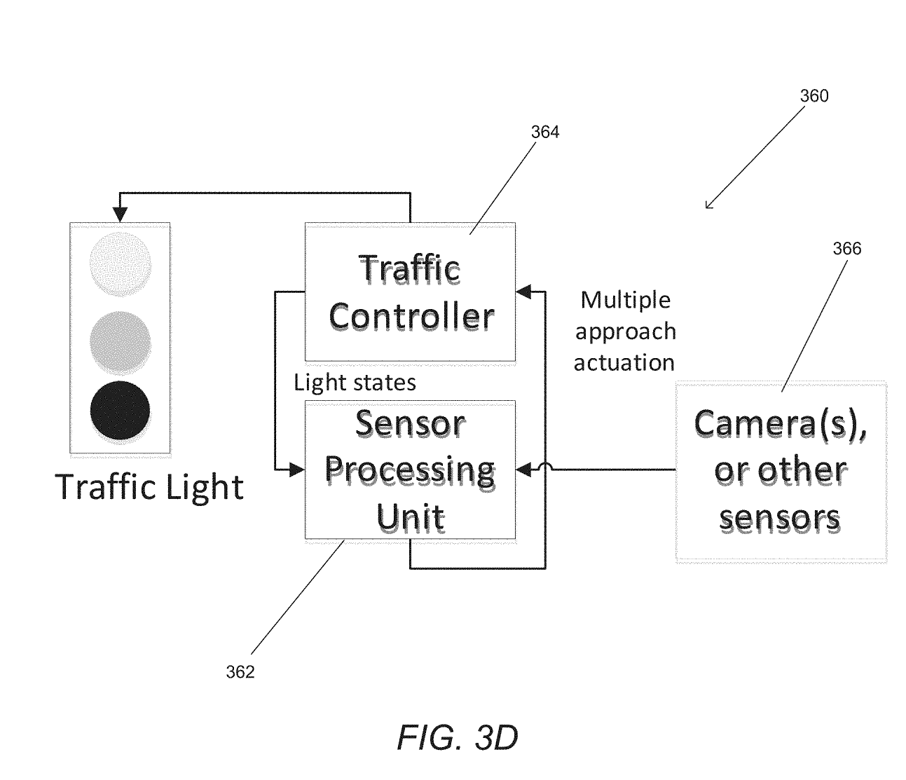

A traffic optimization system in accordance with an embodiment of the invention is conceptually illustrated in FIG. 3A. The traffic optimization system 300 interfaces directly with the traffic controller 302, receiving state information from the traffic controller and providing information to the traffic controller about objects near the intersection and optimal timing of the light. An image sensor 304 or combination of image and/or other sensors is used to collect real time video data of an intersection. In a number of embodiments, the sensor type is a visible camera during the day and a near infrared or thermal infrared camera at night or some combination thereof. High resolution imaging radar or sonar, and non-imaging sensors such as audio microphones, magnetic loops, fiber optic vibration sensors, wireless based vehicle to infrastructure sensors, and internet connected devices such as phones using navigation applications or in-vehicle navigation systems could also be used. Camera based systems, including a combined visible and infrared camera, possibly with the addition of an audio sensor, are utilized within many embodiments of the invention because they provide rich situational awareness, are most easily interpreted by traffic engineers if questions arise, and do not require vehicles to be equipped with any special sensors.

A sensor processing unit 306 processes images and/or other sensor data received from the image sensor 304. As is discussed further below, the sensor processing unit can include (but is not limited to) a CPU and a GPU. The traffic optimization system can also include a traffic optimization processing unit 308. The traffic optimization processing unit 308 can be a separate CPU, or GPU processor or it can be implemented in software on the same processor as the sensor processing unit 306.

In the illustrated embodiment, the traffic optimization unit 308 communicates with a traffic control server system 310. The traffic control server system 310 includes an advanced feature unit 312 and a statistical processing unit 314.

In many embodiments, the traffic control server system can generate predictions of incoming traffic flow using a statistical processing unit, as a function of position, time, and/or road user type. These predictions provide a number of features, including allowing a traffic optimization system to better tolerate the loss of one or more sensors, predicting future traffic flows from current and past data, and provide city planners with better understanding of the forces which drive traffic flow through their cities. The task of computing predicted traffic loads can be posed as a machine-learning problem. In this framework, features such as weather, time of day, day of week, season, visibility conditions (precipitation/fog/smog/glare), road surface conditions (rain/snow/ice), and/or special events can be used to predict traffic conditions without current information. In many embodiments, the specific features that are most informative can be learned using an advance feature unit that utilizes information concerning available data and observed traffic to determine the data inputs that contain the highest informational content. In some embodiments, information such as current traffic loads as measured sparsely or densely on the road network can be additionally used to enhance estimates. In the latter case, kernel-driven techniques, linear estimators such as Support Vector Machines (SVMs), neural networks and/or simulations of vehicle activity can be applied to construct estimates of traffic conditions. These data sources can be combined using regression trees, random forests, neural networks, SVMs and/or other machine learning techniques to produce accurate estimates of traffic conditions.

While a specific traffic optimization system is described above with reference to FIG. 3A, traffic control systems in accordance with various embodiments of the invention can be implemented in a variety of configurations as appropriate to the requirements of a given application including (but not limited to) a single traffic optimization unit which performs all computations directly on the sensor inputs, multiple sensor processing units connected with one or more sensors, or a single sensor processing module with multiple sensors.

FIGS. 3B-3D outline methods for connecting sensors, a sensor processing unit (vision processor), and/or the traffic optimization processing unit to a traffic controller in accordance with various embodiments of the invention. In FIG. 3B, a traffic optimization system 320 is shown including a traffic optimization processing unit 322 that receives light state information from a traffic controller 324 and provides direct and/or indirect control of the traffic signal states based upon sensor inputs 326 received from one or more sensors. In FIG. 3C, a traffic optimization processing system 340 is shown that operates by providing a traffic controller 324 with single approach actuations from a plurality of sensor processing units 344. Each sensor processing unit 344 receives inputs from a camera and/or other types of sensor(s) 346 and determines whether to communicate with the traffic controller 342 to influence traffic signal state on each approach accordingly. In the illustrated embodiment, the traffic controller 342 resolves conflicting directions received from the plurality of sensor processing units 344. In FIG. 3D, a traffic optimization processing system 360 is shown that includes a single sensor processing unit 362 that provides multiple approach actuation to a traffic controller 364 based upon light state information received from the traffic controller and inputs from a camera and/or other types of sensor(s) 366. While specific configurations are described above with respect to FIGS. 3A-3D, any of a variety of configurations of traffic optimization systems can be utilized including (but not limited to) any of a variety of sensor and/or processing configurations as appropriate to the requirements of a given application. Operation of traffic optimization systems in accordance with various embodiments of the invention is discussed further below.

### Traffic Signal Control Processes

Traffic optimization systems in accordance with many embodiments of the invention utilize computer vision processes to detect vehicles and/or pedestrians approaching, exiting, and/or within an intersection. Based upon detected vehicles and/or pedestrians and/or additional information including (but not limited to) information received from a remote traffic control server system, the traffic optimization system can communicate with a traffic signal controller to influence the traffic signal phase of an intersection.

One common issue in object detection is missed detection and false positive rates: where present objects are not detected, or where locations which are not truly a target object are flagged as one. As noted above, a single traffic optimization system may be processing as many as four or more video feeds to detect the presence of vehicles and/or pedestrians in real time. Statistical priors such as object proximity and predicted object location can be used to reduce error rates by discarding detections which violate the statistical priors.

Because traffic surveillance cameras are approximately physically stationary, it is possible to define the locations in which objects are permitted. This area is typically less than ⅓rd of the full area of an image. Furthermore, in a naive search, every size scale is evaluated—this includes searching for a matchbox-sized vehicle in regions which a human would expect to see a full-sized car! Combining these effects can enable ˜25× reduction in the number of candidate windows which are evaluated. Since each window is an opportunity to produce a false alarm, this roughly reduces the false alarm rate by the same dramatic factor. Computational efficiency can likewise be improved, but not as dramatically: even for classical machine learning, features must be computed for every size-scale used in the approximation process. This would restrict total computational savings to a “mere” 10× improvement, (note that the savings figure is approximate). Additional computational efficiencies can be achieved through the allocation of specific classification tasks between different types of processors including (but not limited to) CPUs and/or GPUs present within the traffic optimization system.

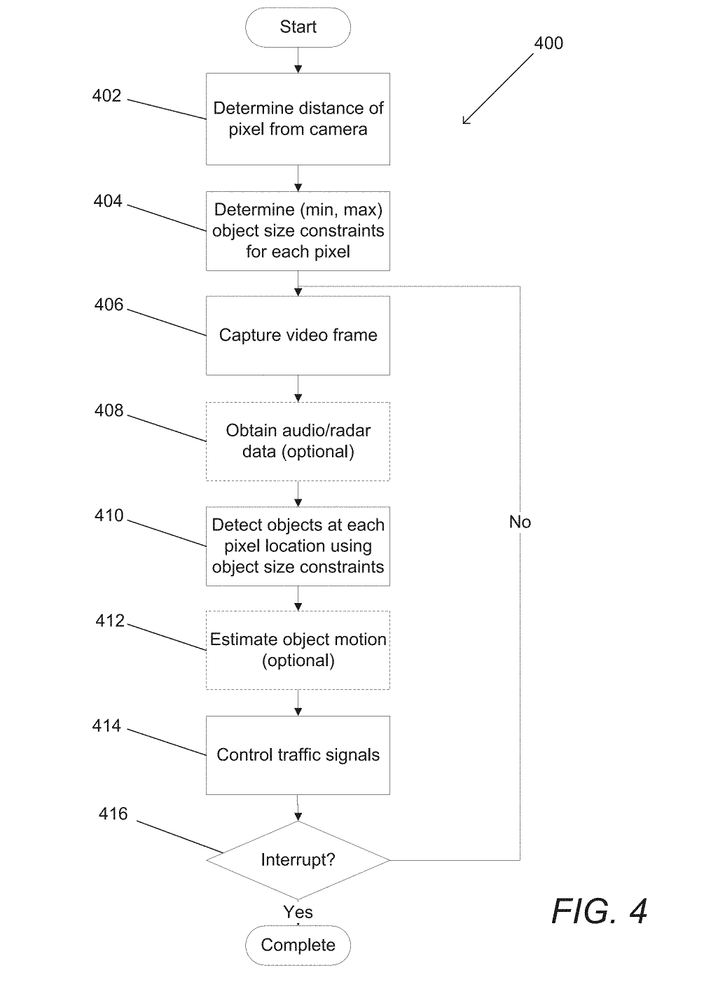

A process for controlling traffic signal phase based upon the presence of vehicles and/or pedestrians detected within images capture by a bird's eye view camera that reduces computational complexity by constraining classification searches based upon (estimated) object distance in accordance with an embodiment of the invention is illustrated in FIG. 4. The process 400 includes determining (402) a distance for each pixel from a camera. In a number of embodiments, the distances can be determined automatically using satellite or aerial images having known geometry. The process can detect specific features within the bird's eye view images and corresponding features within the satellite images (e.g. white lines marked on roads leading into the intersection). In several embodiments, the distances are determined in a semi-supervised manner by manually annotating bird's eye and satellite images with common features. In some embodiments, elevation maps of the region in question are used to enhance the quality of the distance maps above those achievable using a more naive ground-plane assumption. In some embodiments, pose (position+pointing) of the bird's eye view camera is estimated automatically using ground or street-based images of known geometry. These images could, for example, be acquired from Google Street View or similar online services. Ground, aerial and/or satellite imagery can be used jointly for the purpose of creating distance maps.

Distance information can be utilized to impose constraints on the sizes of objects searched at a particular pixel location. In several embodiments, constraints are determined (404) with respect to a minimum and/or maximum object size for a pixel. In a number of embodiments, the minimum and/or maximum object size is specified in terms of minimum and/or maximum pixel widths. In embodiments in which depth information is available, the constraints can be specified with respect to object depth and the constraints at a particular pixel location can be determined in real time based upon a depth value associated with the pixel. As can readily be appreciated, the specific constraints largely depend upon the requirements of a given application.

The process 400 captures (406) a fame of video that can be utilized to detect the presence of vehicles and/or pedestrians. In a number of embodiments, the process 400 also involves capturing data (408) using one or more additional sensor modalities including (but not limited to) audio information, and/or radar information. The captured data can be utilized to detect (410) objects at each pixel location using object size constraints. In several embodiments, historical information concerning detected objects can also be utilized to estimate (412) object motion.

In many embodiments, separate random forest classifiers are utilized to detect each of a number of classes of vehicle and/or pedestrians. In other embodiments, any of a variety of classification techniques can be utilized including (but not limited to) use of a convolutional neural network, and/or use of multiple different types of classifiers.

Based upon information concerning detected objects approaching and/or within an intersection, the process 400 can cause a traffic optimization system to issue instructions to a traffic signal controller to control (414) the traffic signal phase of the intersection. Additional frames of video are captured and processed until the process is interrupted (416) and the process completes.

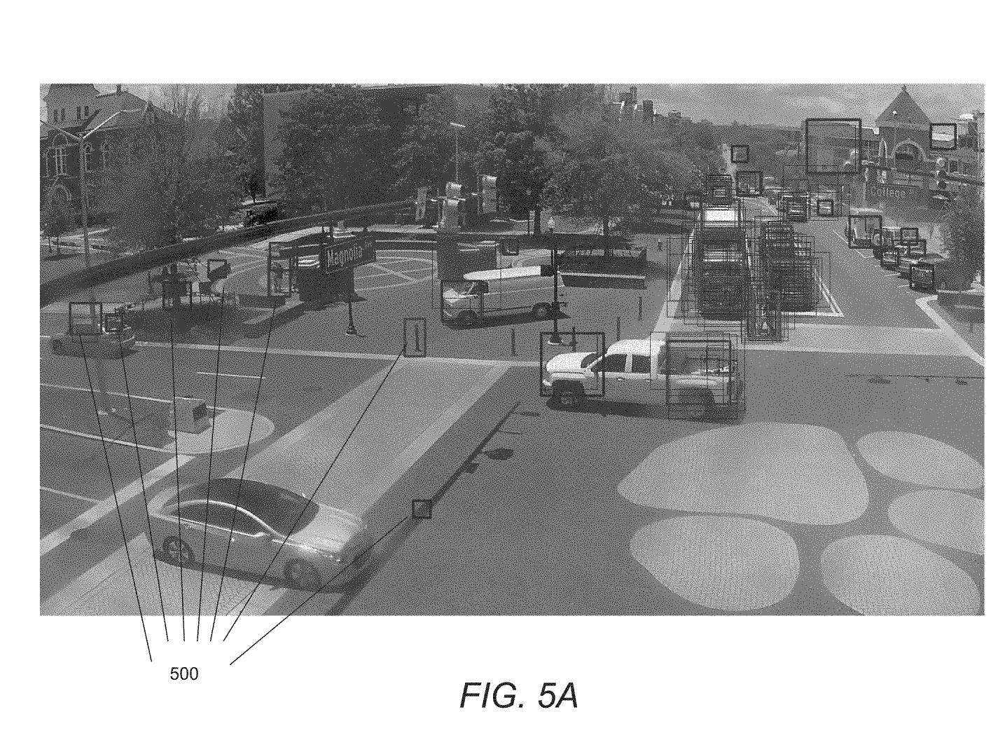

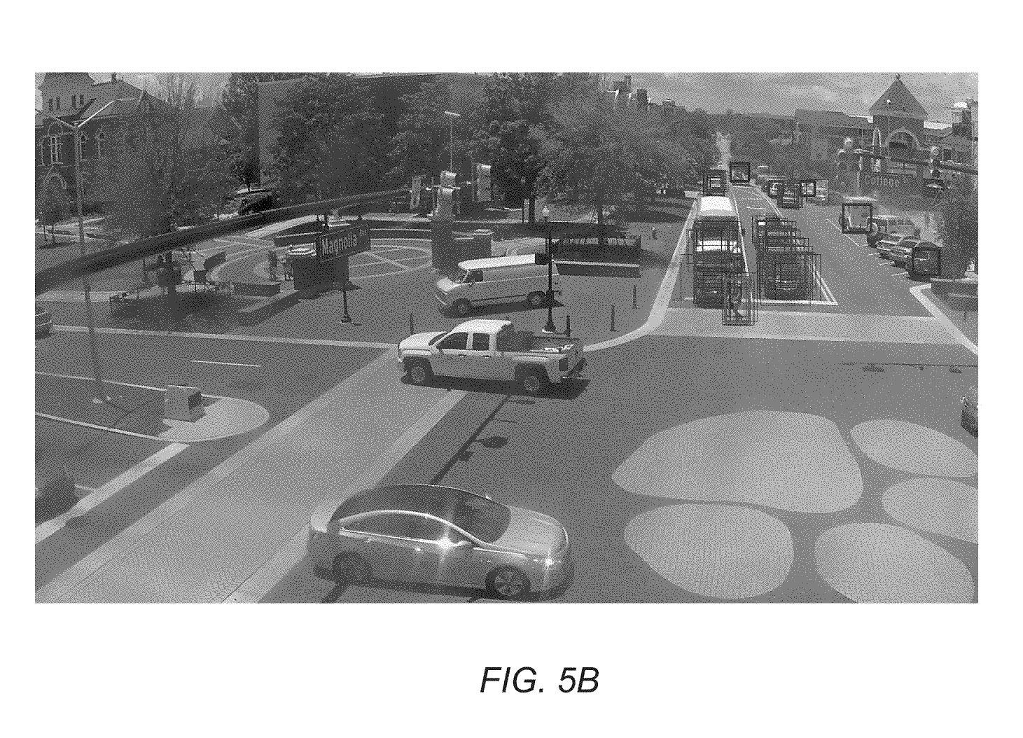

As noted above, the reduction in the number of pixels searched using a mask and the use of a statistical prior to constrain the object detection process can significantly reduce incidence of false positives. The extent of the reduction can be appreciated by a comparison of FIGS. 5A and 5B. FIG. 5A shows bounding boxes indicating the location of detected objects in which all pixels are searched. FIG. 5B shows bounding boxes in which a mask is applied to reduce the number of pixels searched in conjunction with a statistical prior to constrain the object detection process. As can readily be appreciated, false positives such as the false positive 500 evident in FIG. 5A are not present in the detected objects visible in FIG. 5B.

While specific processes are described above with respect to FIG. 4, any of a variety of processes can be utilized to process image data captured by one or more cameras with views of approaches to an intersection as appropriate to the requirements of specific applications in accordance with various embodiments of the invention including (but not limited to) processes that do not constrain the classifiers utilized by the distance to a particular point in the scene and/or that utilizes different forms of classifiers. Various processes for detecting, classifying, and extracting information about objects visible within a scene in accordance with a number of embodiments of the invention are discussed further below.

### Video Processing

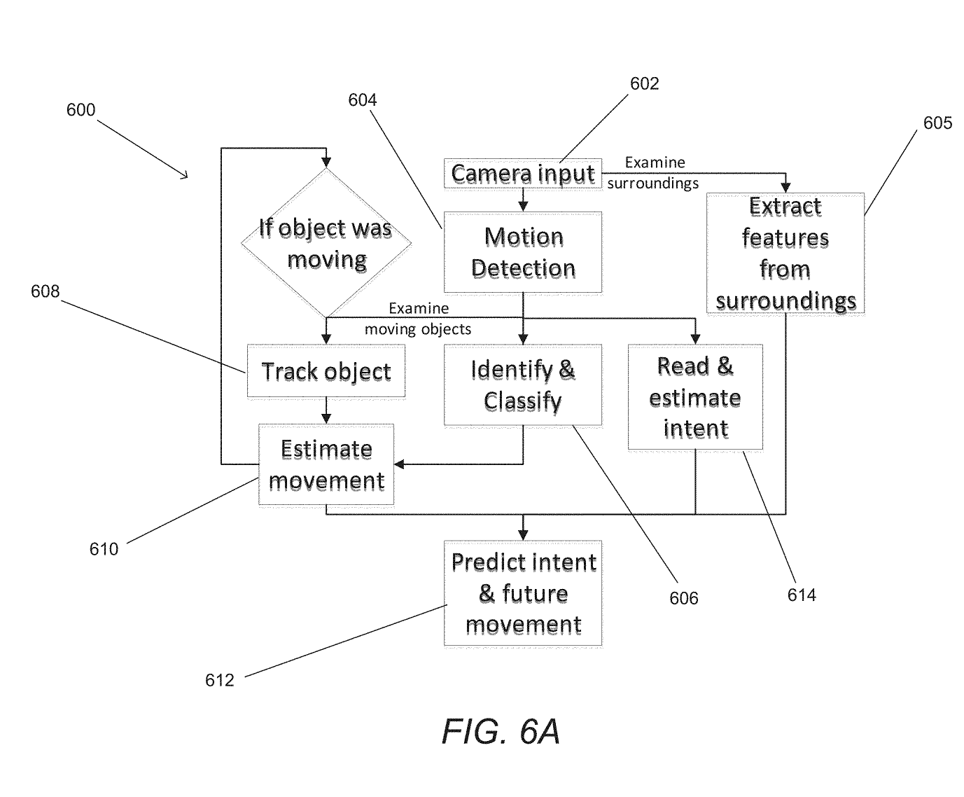

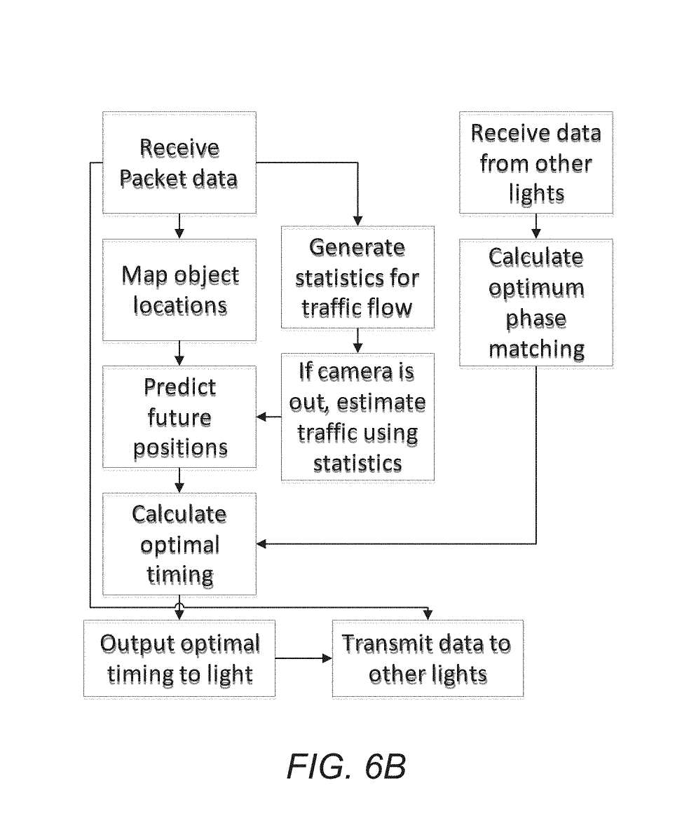

FIG. 6A illustrates operations 600 performed by a sensor processing unit illustrated in accordance with an embodiment of the invention. The camera input 602 can be any imaging sensor. In many embodiments, the sensor processing unit is capable of performing motion detection (604) using the camera input 602. Motion detection (604) can be implemented via numerous methods such as (but not limited to) background subtraction, optical flow, feature tracking, and/or Gaussian mixture models (GMM). In several embodiments, a version of GMM similar to the technique disclosed in KaewTraKulPong, P. and Bowden, R., 2002. An improved adaptive background mixture model for real-time tracking with shadow detection. Video-based surveillance systems, 1, pp. 135-144, the relevant disclosure from which is hereby incorporated by reference in its entirety. This could be extended to make background modelling more robust by treating the initial learning pattern as a mode-by-mode parameter, where each frame increases the age of a mode, thereby decreasing its local learning rate until it reaches the global learning rate, which would be the local mode's minimum learning rate. This would enhance tracking of newly-generated modes by increasing the rate at which their means and variances are adjusted while not adapting the rate by which their individual probabilities are moved.

In certain embodiments, detection of objects approaching and/or within an intersection can be enhanced and/or rendered more computationally efficient by extracting (605) features concerning an intersection's surroundings. In this way, regions of the image that should not contain vehicles and/or pedestrians can be identified and computation reduced by excluding such regions from the areas analyzed to detect (604) motion. Detection (606) of road users (vehicles, pedestrians, motorcycles, bicycles) can be enhanced by using the rich family of pedestrian detection processes. These processes are largely best at detecting rigid objects with fixed orientation (the orientation restriction could be relaxed by further performing the search on incremental steps in orientation space). Most detection processes consist of a feature extraction step, whereby detection parameters such as Histogram of Oriented Gradients, pixels in the LUV color space, Optical Flow parameters, context information such as (distance, time, lighting, weather), and others are collected. For fixed cameras such as in an intersection application, the output of a background subtractor-class process, such as GMM, can also be a good feature. These features, once collected, can be extended by spatial filtering, or multiplying them by a matrix designed to maximize their orthogonality. This can be done to maximize the classification power of individual features, such that subsequent steps in the classification process are able to learn as much as possible from a minimal number of features. For this reason, the orthogonalizing matrix mentioned above can be carefully designed to not merely make the features orthogonal, but also produce stronger classifiers.

After features are extracted, they can be fed into a Machine Learning (ML)-driven classifier. Detectors that can be used for pedestrian detection include (but are not limited to) Support Vector Machines (SVM), Random Forests (RF), Neural Nets (NN), or Convolutional Neural Nets (CNN). In the case of CNNs, often the original pixels are used as features.

Context information, such as the near one-to-one mapping between pixel location and world coordinates, can be used to restrict the possible positions and sizes in which road users can reside. As noted above, this can greatly reduce the computational complexity of detecting (606) road users. Furthermore, the GMM feature can be used to limit the regions in which road users are searched for, because locations which are part of the background model are unlikely to contain road users.

A moving vehicle can be defined as any movement which creates a sufficient movement signature, i.e. is not parked, is within the road pavement, and is identified as a car, motorcycle, bike, or truck by image classification software. Pedestrians can be defined as any other humans not in a motorized vehicle or bike which may be crossing the intersection at any point.

At night, cars can be identified by two headlights, motorcyclists by one headlight, and bikes by a blinking or solid flashlight. Objects without lights will only be detected at night if the camera can see them, which will depend on the ambient street lighting or purposeful illumination from the camera. Vehicles which were previously detected under better lighting conditions may be predicted until a subsequent detection is made using, for instance, a particle filter such as (but not limited to) a Kalman Filter. These particle filters can also be used to provide estimates of object acceleration and velocity, as well as estimates of object position which are superior to that achievable using only a single frame.

Road users can be tracked (608) using unique visual features, (including color, size/aspect ratio and SIFT/SURF features or similar), unique visual markings, wireless signatures (either active transponder or passive emission), their motion and predicted destination, and via their license plates. In many cases information such as vehicle make and model, driver identity, and other features can be extracted from the footage. Road users can be identified and classified (606) using a number of modern computer vision techniques such as convolutional neural networks, machine learning, heuristics such as size, shape, and color, or via vehicle lookup assuming that the license plate can be read. Depending on the quality of footage, more advanced identity features such as human identification can be applied to humans located within the images.

Once a road user has been identified, it can be tracked (608) from frame to frame using visual features identified in the image. This information can extend even past the current intersection such that road users can be tracked through multiple intersections, providing robust measurement of transit times for various classes of objects such as vehicles of different types, bikes, and pedestrians. Information about vehicle speed and direction of travel (610) can be used to predict when a car will arrive at an adjacent intersection.

Several embodiments of the present invention use one camera per approach with overlapping fields of view at the corners of the approaches. This can allow stereo processing of image regions where pedestrians are waiting and can improve the accuracy of pedestrian direction estimation and pedestrian detection, especially at night.

Signals such as (but not limited to) turn signals can be a visible indicator of future movement and these signals can also be extracted and can be used to predict (612) driver behavior. Other features which can be used to estimate intent (614) include acceleration to a yellow light and lane changes prior to reaching an intersection. Pedestrian intent can be inferred as they wait at a crosswalk from the direction in which they face, position at which they stand near the intersection, historical data on pedestrian movement, and pedestrian responses to light state changes among other things.

Audio sensors, although not required for object detection, do provide early warning and enhanced detection of emergency vehicles, information about the speed and direction of movement of emergency vehicles due to the Doppler shift as the vehicle moves, and detection of accidents via the sound that accompanies such events.

Audio sensors also can act as a backup sensor in adverse weather or lighting conditions to detect and identify cars. Because very few, if any, cars are truly silent and most cars have unique audio signatures, it is indeed possible to both detect and classify vehicles based on audio sensors. For simple detection that a vehicle is present it is sufficient to threshold the audio signal based on the peak, RMS, or similar statistical parameter of the signal. Classification can be performed using cross correlation with a data set of known vehicle audio signatures, and/or using a neural network such as a connectionist temporal classification recurrent neural network and/or using a combined use of a transform such as a wavelet or Mel with a machine learning classifier. Audio sensors can be used for detecting other audio signatures from pedestrians or other road users if the magnitude of the sound is sufficient. If an audio sensor is present at each approach, discerning the direction of arrival is possible, which can provide an estimate of vehicle approach direction and lane of arrival. The shift in the received frequency signature due to the movement of the vehicle allows estimation of whether the vehicle is approaching or exiting the intersection.

There are cases where an object is no longer moving but was moving in the past and is still in the intersection. The most common case of this is during times of peak traffic where multiple cars may be stuck in an intersection. Since the most computationally efficient algorithm for detecting vehicles is often to look for motion, it is important to track objects that stop moving even after they lose their motion signature. By tracking each object's location, velocity, and acceleration, this can readily be achieved. The preferred embodiment of this prediction and tracking includes a particle filter, such as (but not limited to) a Kalman Filter, potentially using the Hungarian algorithm or another cost-minimization algorithm to match predicted tracks to recent detections

A sensor processing unit in accordance with many embodiments of the invention can coalesce this information extracted from the video footage into a compact data representation indicating the location, speed, acceleration, and identity of each object, its predicted motion based on statistics of previous vehicles, statistics of where that vehicle usually travels at a certain time, and its signal indicators. When this is done over a sufficiently large window of time it provides a very accurate prediction of future traffic flow at nearby lights which can be used by a traffic control server system to further optimize large scale intersection networks. Ideally the traffic optimization system at a given intersection would output a data packet containing a set of road user detection features. The specific features contained within a given data packet will typically depend upon the requirements of a given traffic control server system and/or application.

### Traffic Signal Phase Control

FIG. 6B shows the block diagram of the traffic optimization unit which can be used to minimize some weighting function, and hence optimize the light timing or improve traffic flow.

In many embodiments, a traffic optimization processing unit receives data from each camera in the form of a metadata packet providing information including one or more of the following pieces of information for each road user:
vehicle type (car, truck, motorcycle, bike, pedestrian),
vehicle color,
make,
model,
visual features,
direction of arrival,
position,
lane,
velocity,
acceleration,
turn signal state,
emergency light state,
driver behavior indicator (normal, aggressive, DUI, texting while driving),
accident Yes/No, and
License plate number.

Where not limited by occlusion, limited resolution, and processing requirements, some or all of these features can be extracted, and additional features can also be added if desired. For example, these additional features could be added over the course of sequential frames of a video from a single camera, or added by another computer vision system as the road user passes a different intersection.

In a number of embodiments, the traffic optimization processing unit can attempt to provide information including (but not limited to) one or more of the following with respect to each approach:
amount of traffic up to light,
amount of backed up traffic after light,
cars still clearing intersection,
density of road users as a function of vehicle type and position on the road
a list of some or all present road users, with their associated position, velocity and/or class
time of day/night,
weather,
visibility conditions (fog/smog),
sun glare (typically sunrise/sunset),
accident,
reduced traction condition (rain/snow/ice),
traffic anomaly,
special event, and
emergency vehicle.

In many embodiments, data fusion produces high fidelity data for prediction and traffic optimization. In these cases, a hierarchy of data quality can be used, preferring data of higher quality or trustworthiness when possible. Possible data sources (in descending order of preferential nature) include (but are not limited to):

a) Current data from local sensors

b) Current data from other systems' sensors

c) Current data from vehicle-based GIS systems

d) Simulated road network/road user state

e) Historical statistical traffic behaviors

In many embodiments, performing sensor fusion between vehicle-based GIS systems and simulated network state is desirable. This is useful because it is possible that a GIS detection also corresponds to a simulated vehicle path—it is possible that the vehicle was correctly detected previously using a higher-fidelity system while it was visible, and subsequently was simulated thereafter. This can be handled, for example by estimating each vehicle's predicted current state for example by using a simulation, or alternatively by using a particle filter and conditional probabilities between the GIS platform-detections and the distributions. Using one of these techniques, the likelihood that a GIS detection matches a simulated vehicle position can be estimated. Sufficiently probable GIS detections can be treated as identical to the those found using the simulation technique. Detections which fail to match are injected into the simulation state as a new detection.

In many embodiments, information generated by the traffic optimization processing unit can be sent to nearby controllers and/or a traffic control server system. In several embodiments, the traffic optimization system transmits to adjacent connected intersections, as well as the traffic control server system. The transmitted information can help other traffic optimization systems improve overall traffic flow. Transmitted packets of data may include projected statistics such as expected incoming traffic load, which may be inferred from datasets provided from other intersections. Absent traffic statistics can also be filled in by real-time data from an auxiliary dataset, such as Traffic Data from Google Maps. The geometry of each intersection can be recorded on setup and this can be used to map object locations in image space into a map of where cars physically are relative to the intersection. Mapping the location of cars in this way into a geographic information system can make predictions of future position easier and more quantitative.

Not all the information specified above is necessary to make optimal decisions with respect to control of the traffic signal phase at a given intersection. In several embodiments, the traffic optimization system captures as much information as possible, thereby increasing the performance of the signal timing optimization algorithm.

The future actions of drivers can be reliability predicted at two levels. Macro traffic behavior can be obtained by measuring traffic flow using this system and applying statistics to the flow to estimate future flow rates at different locations and times. Micro traffic is traffic due to individual vehicles, pedestrians, or intersection users. Because traffic optimization systems, in many embodiments, can provide identification data on individual vehicles, and because drivers often follow a small number of routes and travel at statistically predictable times, it can be predicted how traffic from individual drivers will affect the net traffic flow and at which times this will occur. Because people can change routes if other preferential routes are found, a statistical model for how likely this behavior is in each driver can be derived from the actual driver behavior. In a way, this allows the traffic control system to predict where each car will drive ahead of time and use of this data can enhance the improvements in traffic flow achieved by optimizing traffic signal phase timing at various intersections.

Predicting behavior can also go further than just knowing where a car will turn. Using statistics aggregated from all road users, along with statistics on the vehicle in question during different times, the personality, aggressiveness, and/or likely level of intoxication of a driver, bicyclist, pedestrian, and/or other object detected in video footage can be ascertained.

In many embodiments, the traffic signal phase control process seeks to produce the “ideal” light timing for one or many intersections, provided the available information. Factors in this “ideal” timing could for example be vehicle wait times, accident/injury risk or the presence of emergency vehicles. By defining an “Error Function” which is to be minimized, this task can be modeled as a traditional mathematical optimization problem. This problem can then be solved by the rich mathematical optimization literature. One straightforward approach for the “Error Function” would be to simulate the behavior of the intersection over the upcoming several minutes, provided a hypothetical timing plan. Various parameters in the outcome, such as vehicle wait times (potentially as a function of vehicle type), would be described as components in this error function.

In several embodiments, the optimization algorithm simulates the net wait time which would be generated for multiple possible timing configurations. The minimum of the wait times is a sum of the time each car will have to wait at the light. One challenge with using wait times directly is that vehicles waiting at cross streets during times of peak traffic may wait for multiple minutes before being served a green. Thus, the optimization function can more highly wait those who have been waiting longer. This can be achieved by using the square of the wait times (or some other appropriate waiting) as the optimization criterion.

In many embodiments, the traffic signal phase control optimization criterion can assume that there are an equal number of people in each vehicle which is often not the case. Thus, certain vehicles such as buses can be weighted more highly by multiplying the wait time by the number of riders (or expected number of riders) in the vehicle. This is very hard to measure from camera footage but fixed values can be given to certain types of vehicles such as busses to account for this effect. This can, for example, be accounted for by multiplying a weight by the actual wait time of each car.

(i)

W(i)*WaitTime

Σ₁ⁿ (1)

Equation 1 illustrates an embodiment of the optimization strategy where the sum is the net square of the weighted wait times of all users. There are certain cases where this traffic signal phase control optimization criterion must be ignored to ensure the safety of vehicles and pedestrians at a light. Emergency vehicle preemption is one obvious case, but there are several others that could drastically reduce accidents if implemented correctly.

Some examples include:
If a driver is speeding up to a yellow light, the algorithm can predict with high probability that the driver will run the yellow/red light. The light could be held red in the opposing direction until the vehicle completely exited the intersection or would exit the intersection before opposing vehicles accelerated. Other timing schemes using this information could also be devised.
If an emergency vehicle with its lights flashing is detected, the light could go green in the forward direction of the vehicle and in the left turn lane. Minimum green, yellow, and red times shall still be respected.
If a pedestrian is still in an intersection after the pedestrian walk sign has turned red and the pedestrian timer has timed out, the light may remain green in the direction of pedestrian crossing until the pedestrian can get across. This is especially a problem for people with disabilities and the elderly who cannot walk across the intersection at the rate of an average pedestrian. If pedestrians or bicycles traverse the intersection sooner than expected, the pedestrian hold can be removed allowing a more rapid switch back to a direction of traffic flow.

There are times when pedestrians cross an intersection without a walk signal from an intersection. Although this is illegal in most places it is still a public safety hazard and may be partially preventable with better light timing. In cities with pedestrian populations which are prone to cross lights without a walk signal, weighting functions which more heavily weight pedestrians could be used. A similar approach could be taken for cities with significant bike populations since bicycle riders are more willing to wait if stopped and less willing to stop abruptly.

Another feature of the optimization system is the ability to provide selectively optimized routes for different types of road users. Because the sensor network provides data on the types of road users, an algorithm can selectively weight or optimize based on road user type. One embodiment of this would be for bicycle optimization on corridors specifically designed for bicycle traffic. Several cities have dedicated bike lanes or roads designed primarily for bicycle traffic and yet lights along these routes tend to actuated primarily based on vehicle sensors. Pedestrian push buttons are more difficult to actuate on a bike and require the cyclist to stop. Because the likely future path of cyclists relatively predictable, an optimization can be implemented which prioritizes cyclists, minimizing stopping and/or waiting at intersections. Just like with conventional vehicle traffic it is possible to group cyclists into platoons and shuttle them through intersections in a time efficient manner.

There are also exceptions to a traffic signal phase control optimization criterion which are based on obtaining city-wide optimization, even if that implies that vehicles, bikes, and pedestrians wait slightly longer at a single light. Using the wait minimization optimization algorithm on a city-wide network of intersections will converge on this approach. Where vehicle and/or driver identification is implemented within a traffic control system, including these criteria as lower-priority criteria can improve overall traffic flow. Other non-timing based criteria which may be optimized include minimizing emissions, minimizing traffic noise, minimizing the number of vehicles required to stop, and even minimizing the time-dollar equivalents of those using the intersection. Any of these approaches form a possible implementation of the invention.

One method for improving on the optimization scheme described is to incorporate a model for adaptive rerouting. As vehicles approach an intersection the optimization algorithm simulates possible timing plans and possible alternate routes for platoons of vehicles traveling along a corridor. If drivers are informed that a deviation in their route will result in a reduced wait time many drivers will opt for the alternate route. If it is known how many drivers will take the alternate route, that will change how many vehicles will be waiting at the light in the future, which in turn changes the optimization algorithm and the resulting light timing. What is unique about this approach is that both the light timing and the drivers' response to that timing can be simulated ahead of time and then an optimized timing and route can be chosen concurrently in real time. Some advanced navigation applications, such as (but not limited to) the Waze service provided by Waze Mobile Ltd., do attempt adaptive rerouting, but they cannot adaptively reroute based on the real time state of an intersection (mainly because they lack access to this data and cannot completely predict it). Current optimization approaches can estimate optimal light timings based on the real time state of the intersection (limited only by the availability and accuracy of the sensors, and the time horizon of the system), but they do not take into account that these light state changes could cause some vehicles to reroute before or at the intersection. The approach would enable real time adaptive load balancing on road networks to spread traffic flow across all viable road networks, and to fill short interval holes in traffic. There may also be small modifications to the processes that improve reliability. For instance, it is possible for vehicles to be missed by the detection processes. In order to mitigate the consequences of these errors, the process may be designed to occasionally serve intersections, even in the absence of detected vehicles, reducing road user frustration. if an undetected road user is indeed present As can readily be appreciated, the specific manner in which a traffic optimization system determines the timing of traffic signal phase changes is largely dependent upon the requirements of a specific application. A variety of general heuristics for traffic signal control are set out in U.S. Provisional Application Ser. No. 62/404,146, the disclosure of which is incorporated by reference in its entirety above.

### Leveraging GPUs to Improve Computational Efficiency

Classical machine learning techniques have been applied to object detection. These techniques typically compute statistical representations of the image (or sequence of images), such as image color (in RGB space, or another space such as LUV or HSV), image gradient magnitude, image gradient orientation, measures of object movement (often called “optical flow”), and other contextual information. These features may be analyzed directly, but are more often averaged on some scale or combination of scale. These averaging techniques can include grid-like structures, radial averaging cells, or efficient general rectangular features such as Harr filters. These features (averaged or otherwise) can then be processed with a statistical model, such as SVMs, cascades of classifiers, random forests, Bayesian methods, neural networks, or others. Often features are computed for the entire image, and subsequently, the statistical model is repeatedly applied to each candidate location and size, an extremely computationally expensive operation. This technique can be accelerated by approximating features at a reference size-scale and then extrapolating to nearby scales.

In many embodiments, a number of random forest classifiers are utilized to detect different types of objects. Random forest classifiers can be trained that include different classes of objects including (but not limited to) bicycles during the day, bicycles at night, vehicles during the day, vehicles at night, and pedestrians. In a number of embodiments, significant computational efficiencies can be achieved by distributing processing between GPUs and CPUs within a sensor processing unit. When random forests are utilized, the classifier can be terminated at a particular pixel location when the likelihood (or score) of the location containing a detected object falls below a threshold. As most pixels within a given frame likely will not contain a detected object, significant computational savings can be achieved by early termination of a classification process with respect to pixels that are deemed to be highly unlikely to contain an object. Termination of a process in this way is better suited to processing by a CPU as GPUs are configured to apply the same processes to a set of pixels. In several embodiments, accordingly, one or more GPUs is used to identify features within regions of the image that can contain objects. The features are then provided to classification processes executing on one or more CPUs. In many embodiments, separate classification processes execute on separate cores of a CPU. In this way, the sensor processing unit can exploit the parallelism of the GPU to perform feature detection and achieve computational savings through early termination by executing the classifier using the features identified by the GPU with respect to each pixel independently on the CPU. As can readily be appreciated, the specific manner in which various processors within a traffic optimization system are utilized to process received frames of video are largely dependent upon the requirements of a given application.

As noted above, traffic optimization systems in accordance with various embodiments of the invention can take on a variety of forms depending upon the requirements of specific applications. In a simple form, a traffic optimization system can include a single image sensor. In a number of embodiments, traffic optimization systems can use multiple imaging modalities including (but not limited to) near-IR and visible light. More complex implementations can include multiple image sensors and/or sensors that provide additional sensing modalities. Traffic optimization systems in accordance with many embodiments of the invention can also include network interfaces to enable information exchange with remote servers and/or other traffic optimization systems. In many embodiments, traffic optimization systems can be implemented on the hardware of a smart camera system that includes a system-on-chip including a microprocessor and/or a graphics processing unit in addition to an image sensor, and a wireless communication module. Such smart camera systems typically also include one or more microphones that can be utilized to provide directional information and/or velocity information with respect to emergency vehicle sirens and/or detect crashes and/or the severity of crashes based upon noise generated during a collision. As can readily be appreciated, any of a variety of commodity and/or custom hardware can be utilized to provide the underlying hardware incorporated within a traffic optimization system as appropriate to the requirements of a given application.

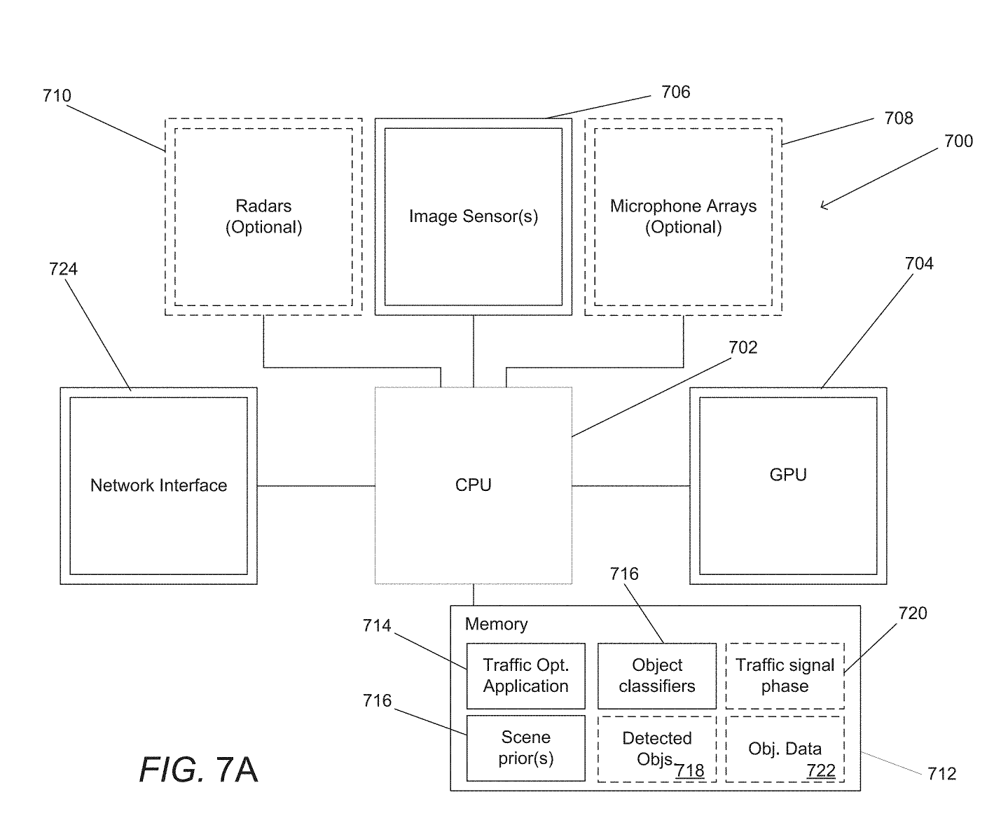

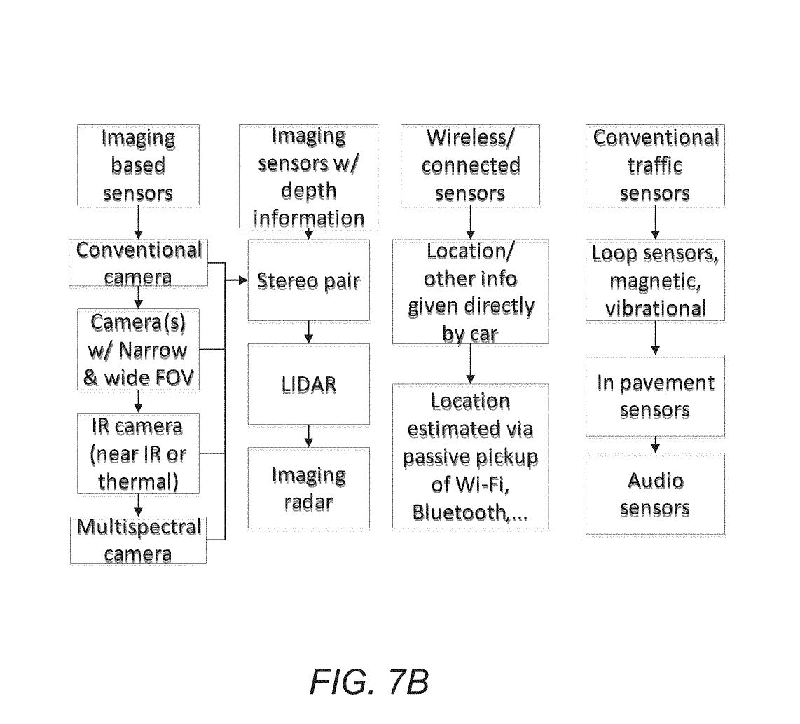

A traffic optimization system that can incorporate a variety of sensors utilized to perform object detection in accordance with an embodiment of the invention is illustrated in FIG. 7A. The traffic optimization system 700 includes a processing system configured to process sensor data received from an array of sensors. In the illustrated embodiment, the processing system includes a central processing unit 702 and a graphics processing unit 704. As can readily be appreciated, the processing system can be implemented in any of variety of configurations including (but not limited to) one or more microprocessors, graphics processing units, image signal processors, machine vision processors, and/or custom integrated circuits developed in order to implement the traffic optimization system 700. In the illustrated embodiment, the sensors include one or more image sensors 706, an (optional) microphone array 708, and an (optional) radar system 710. While specific sensor systems are described below, any of a variety of sensors can be utilized to perform vehicle and/or pedestrian detection as appropriate to the requirements of a given application.

In many embodiments, the image sensor 706 is a single RGB camera. In several embodiments, the camera system includes multiple cameras with different color filters and/or fields of view. In certain embodiments, the camera system includes an RGB camera with a narrow field of view and a monochrome camera with a wide field of view. Color information can be utilized to perform detection of features such as (but not limited to) people, objects and/or structures within a scene. Wide field of view image data can be utilized to perform motion tracking. As can be readily appreciated, the need for a camera system and/or specific cameras included in a camera system utilized within a spatial exploration system in accordance with an embodiment of the invention is typically dependent upon the requirements of a given application. The image sensors 706 can take the form of one or more stereo camera pairs (optionally enhanced by projected texture), a structured illumination system and/or a time of flight camera. In certain embodiments, the image sensors 706 can include a LIDAR system. As can readily be appreciated, any of a variety of depth sensor systems can be incorporated within a traffic optimization system as appropriate to the requirements of a given application in accordance with various embodiments of the invention.

In a number of embodiments, the traffic optimization system 700 includes one or more microphone arrays 708. A pair of microphones can be utilized to determine direction of a noise such as a siren or sounds generated during a collision. A third microphone can be utilized for triangulation. In several embodiments, the repetitive quality of emergency vehicle sirens can be utilized to measure velocity with which an emergency service vehicle is approaching an intersection based upon the Doppler shift of the siren. As can readily be appreciated, the specific manner in which the processing system of a traffic optimization system processes audio data obtained via a microphone array is largely dependent upon the requirements of a given application.

In certain embodiments, the traffic optimization system 700 includes one or more radar systems 710 that can be used to perform ranging and/or determine velocity based upon Doppler shifts of radar returns. The number of reflections of a radar chirp received by the radar system can be utilized to determine a number of vehicles present and the Doppler shift of each return can be utilized to estimate velocity. The resolution of radar systems is typically less precise than that of visual or near-IR imaging system. Therefore, sensor fusion can be utilized to combine object detection based upon image data with radar information related to the number of objects that are present and their instantaneous velocities. As can readily be appreciated, the specific manner in radar data is utilized and/or sensor fusion is performed by the processing system of a traffic optimization system is largely dependent upon the requirements of a given application.

The CPU 702 can be configured by software stored within memory 712. In the illustrated embodiment, a traffic optimization application 714 coordinates capture of sensor data using the sensor systems. The sensor data is processed by the CPU 702 and/or GPU 704 to detect objects. As noted above, scene priors 716 stored in memory can be utilized to improve computational efficiency. In addition, certain tasks that are readily parallelizable can be handled by the GPU such as (but not limited to) feature detection. Processes such as (but not limited to) classification can be implemented on the CPU to enable early termination when likelihood of detection of a particular object falls below a threshold. In several embodiments, parameters (716) describing object classifiers are contained in memory 712 and the processing system utilizes these object classifiers to detect objects within image data received from the sensors. Data describing the detected objects (718) is stored in memory 712 and processed by the processing system using information concerning the current traffic signal phase retrieved from a traffic signal controller and stored in memory 712 to generate instructions to modify the traffic signal phase. In many embodiments, additional data concerning vehicles 722 can be received from other traffic optimization systems and/or remote traffic control server systems via a network interface 724. In many embodiments, data concerning objects (718, 722) is dynamic and is continuously updated as the traffic optimization system receives additional sensor data and messages.

In many embodiments, sensor data captured by multiple modalities (e.g. image data and range data) are utilized to perform detection and/or classification processes. When a vehicle, and/or person are detected, the processing system can initiate an object classification to develop additional metadata to describe the object. In several embodiments, the metadata can be compared against received object data 722 to associate additional metadata with the detected object when a match is identified. Accordingly, the processing system can send messages to a remote traffic control server system enabling the continuous updating of the location and/or other characteristics of an object as it moves throughout a network of intersections.

In many instances, the spatial exploration system includes a network interface 724. The network interface 724 can be any of a variety of wired and/or wireless interfaces including (but not limited to) a BLUETOOTH wireless interface, and/or a WIFI wireless interface. In several embodiments, the wireless interface 724 can be used to download object data describing vehicles and/or pedestrians that are likely to be approaching an intersection based upon data gathered by traffic optimization systems at proximate intersections. In many embodiments, MAC addresses of devices present on pedestrians and/or vehicles can be utilized to track objects between intersections. As mobile devices announce their presence to the network interface 724 the data can be utilized to identify the device based upon MAC address information (and/or other information) of previously identified mobile devices received via the network interface 724. As can readily be appreciated, traffic optimization systems can receive and/or retrieve any of a variety of different types of information via a network interface 724 that can be useful to specific applications as appropriate to the requirements of those applications.

While a number of specific hardware platforms and/or implementations of spatial exploration systems are described above with reference to FIG. 7A, any of a variety of hardware platforms and/or implementations incorporating a variety of sensor systems, output modalities, and/or processing capabilities can be utilized as appropriate to the requirements of specific applications in accordance with various embodiments of the invention. Additional variations on traffic optimization system hardware are discussed further below.

### Alternative Detection Modalities

The techniques described in this document need not be restricted to optical camera detectors. FIG. 7B outlines several alternative sensing tools with imaging capability that can directly replace camera based sensors and still remain within the scope of the present invention, often utilizing very similar or identical processing. Non-imaging sensors can also be used in conjunction with various systems similar to those described above as will be explained subsequently.

Existing emergency preemption systems use auditory, infrared, or network-connected GPS methods to detect properly equipped Emergency Vehicles (EVs). Since the EVs are equipped with specially-designed hardware, these techniques can be more robust than an optical detection: the custom detection mechanism can be used in addition to (or be given priority over) other EV detection tools.

Already-present magnetic-loop detectors can be used to confirm other detections. Since the loop is active for some period of time while the vehicle is present, an estimate of the length of the vehicle coupled with its speed can be produced from the sensor, enhancing other detection methods. In a simplified one-dimensional model, using the magnetic sensor as a point source, the sensor will register a car for T=L/V seconds, where T is time (in seconds), L is the length of the vehicle (meters), and V is the velocity of the vehicle (meters/second), assumed to be positive. Since it is likely that the velocity of vehicles will be known using CV algorithms, this will likely be used as a measure of vehicle length. Already-present optical traffic cameras can also serve this purpose, although our experience has shown that their performance is inferior to this invention.

On-board Vehicle-to-Infrastructure or Vehicle-to-Vehicle radios, potentially using DSRC, will soon be communicating information packages to nearby receivers, such as the SAE J2735 Basic Safety Message. These safety messages will include information such as the vehicle's speed, brake state, position, identification and more, which can be integrated into the data received and analyzed by the intersection.

Many vehicles also act as Bluetooth and WI-FI enabled devices. These vehicles can be detected using the signatures of their devices, which often transmit signals searching for available devices and networks (or in the process of utilizing already-established connections). Monitoring the variation of signal power (or, less likely, their Doppler shift), provides a measure of road user position relative to the intersection, and potentially road user speed. Although many vehicles are not equipped as Bluetooth and WI-FI devices, their passengers often carry cellular phones, and other devices which are so-equipped. These devices can be detected instead.

LIDAR technology has been dropping in cost recently—a LIDAR system may be used in place of, or in addition to other detectors. These systems are especially likely to mitigate the problem of vehicle occlusion (two vehicles visibly overlapping)—a problem which the addition of a depth map readily mitigates.

RADAR technology has many characteristics and performance measures of LIDAR, and also provides a reliable measure of Doppler shift (and therefore road user velocity in the direction of the intersection). The high metallic content of vehicles is likely to make them excellent RADAR targets. A phased-array RADAR would be capable of producing beams in many directions and is another possible sensor to be used as the imaging device of the present invention. One unique advantage of a RADAR type sensor is that the same electronic hardware can be used for both radar imaging and vehicle to infrastructure and infrastructure to vehicle communication. If the radar operated on an ISM band which was also used by vehicles for object avoidance and collision prevention radar, virtually no additional hardware costs would be necessary to incorporate vehicle to infrastructure communication capability. As the vehicle fleet shifts to more advanced and autonomous capabilities, passive RF receiver sensors which listen for vehicle radars could also be integrated into this sensor package.

Some modern cameras are being produced with four or more spectral bands, such as OmniVision's RGB+IR sensor. Additional frequency diversity provides a robustness against the day-night cycle—especially when considering that humans are unable to see in the IR band, allowing the system to have illumination at all times without disturbing road users. This would, of course, imply the additional use of IR (or other spectral band) LEDs to illuminate the target. These additional bands also have the excellent property of fitting in nicely with the other computer-vision algorithms—many standard optical computer vision algorithms can simply be extended to utilize an additional color. Some of these processes will need to treat the non-optical color differently, depending on if its noise characteristics are different from those of RGB, for example.

Similar to LIDAR (and to a lesser degree RADAR), stereo cameras provide a dense depth map, which can be used to disambiguate occlusion and provide a more robust depth map. Knowing depth accurately allows for the precise location of each pixel in 3-space, which will also make the reading of license plates (and to a lesser degree, detection of emergency vehicles) easier, because most geometric uncertainties will be removed (assuming the license plate is perfectly vertical, that is). We additionally intend to use a limited form of stereo vision to detect pedestrians waiting at crosswalk regions. Overlapping camera fields-of-view in these regions will allow for more accurately locating pedestrians in 2-space near the corners, improving the prediction of which direction the pedestrian intends to cross on.

One major tradeoff with camera based sensors for this application is the need to simultaneously have the field of view to see the intersection at the stop-line, the ability to detect EVs in the distance, and the need to detect pedestrians and read license plates of nearby vehicles. These requirements demand a very conflicting camera field-of-view (FOV), because the license plates and EVs require a narrow FOV so that the local image in that region has a sufficiently high resolution to make the detection, while the pedestrians and nearby vehicles may require a wide FOV to be able to see the entire region. Using two or more cameras would allow for multiple FOVs to be used. For instance, two cameras could be used with different FOVs and viewing areas—one could be focused in the distance with a narrow FOV while a second emphasizes the near field. Alternatively, three could be used—one to detect EVs, a second to read license plates nearby and a third to see nearby vehicles and pedestrians. As can readily be appreciated, the specific combinations of cameras and/or other sensors are largely dependent upon the requirements of a given application.

Likewise, a single-camera-per-approach system has the limitation that it is unable to directly detect vehicles within the intersection. Adding a very wide FOV camera (or potentially omnidirectional) near the intersection provides information about the state of the interior of the intersection as well, improving the ability to protect road users who are inside the intersection.

As can readily be appreciated from the above discussion, any of a variety of sensors can be utilized to implement a traffic optimization system as appropriate to the requirements of a given application. The richness of the data generated by a traffic optimization system typically depends upon the sensing modalities available to the traffic optimization system. Information that can be collected over time by traffic optimization systems in accordance with certain embodiments of the invention are discussed further below.

### Tracking Extracted Information

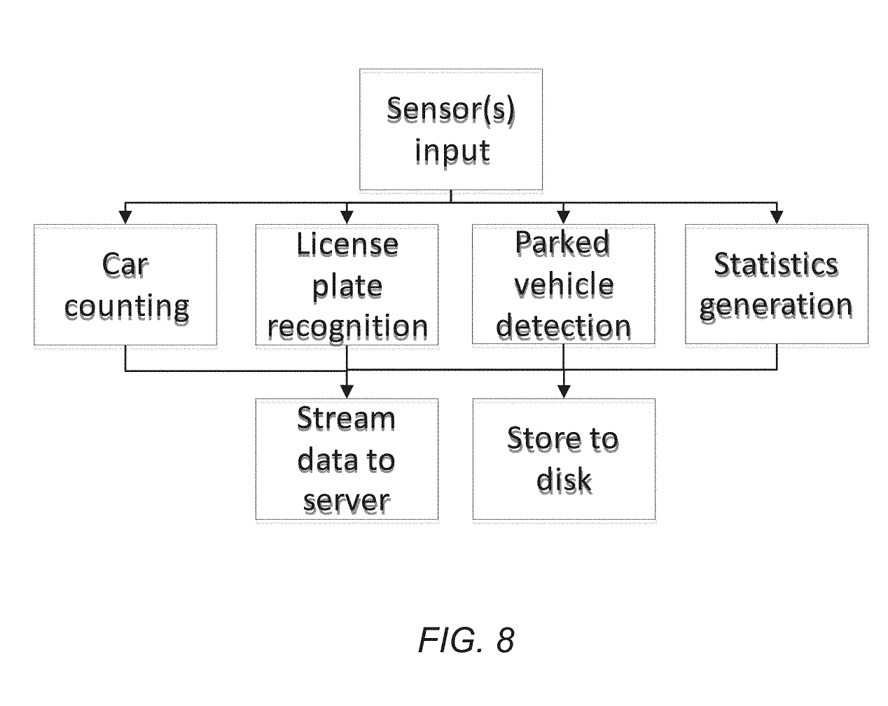

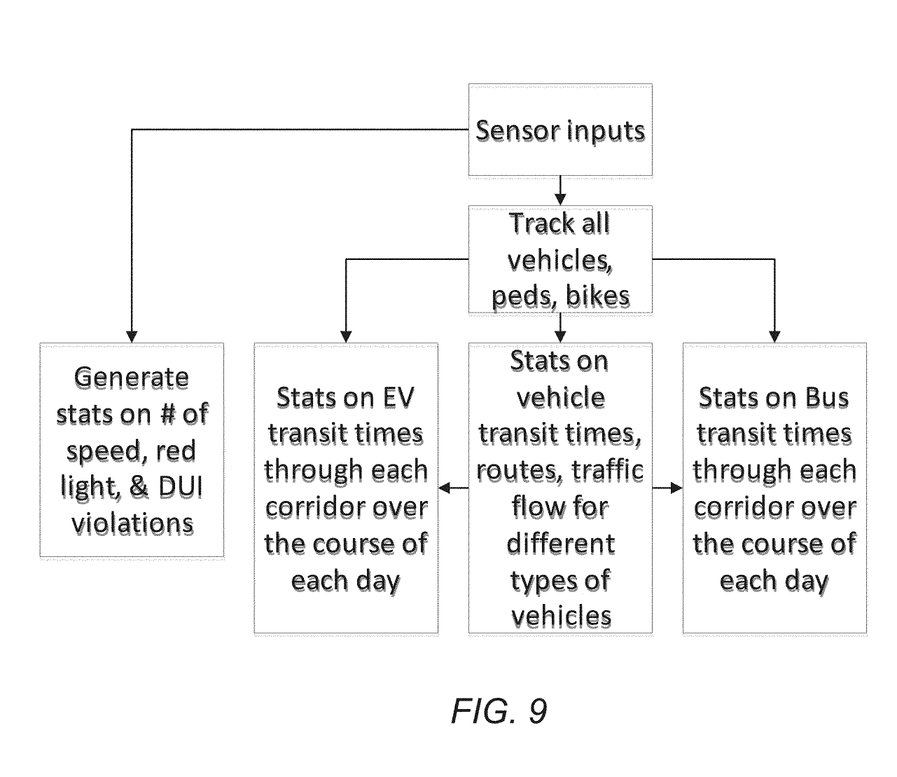

FIGS. 8 and 9 show several of the statistical features which can be usefully extracted from image data obtained by traffic optimization systems in accordance with various embodiments of the invention. Although not exhaustive, these features can be used to better inform a traffic signal phase control process of how to make decisions and can also be insightful for city planning, parked vehicle detection, and many other applications. For example, objects within the footage can be tracked between frames and between intersections. By doing this, accurate counts of each type of vehicle, bike, pedestrian, and other moving objects can be made and statistics on transit time, routes taken by individual drivers or group route behavior, traffic flow during different parts of the day, and usage statistics can be gleaned from this data.

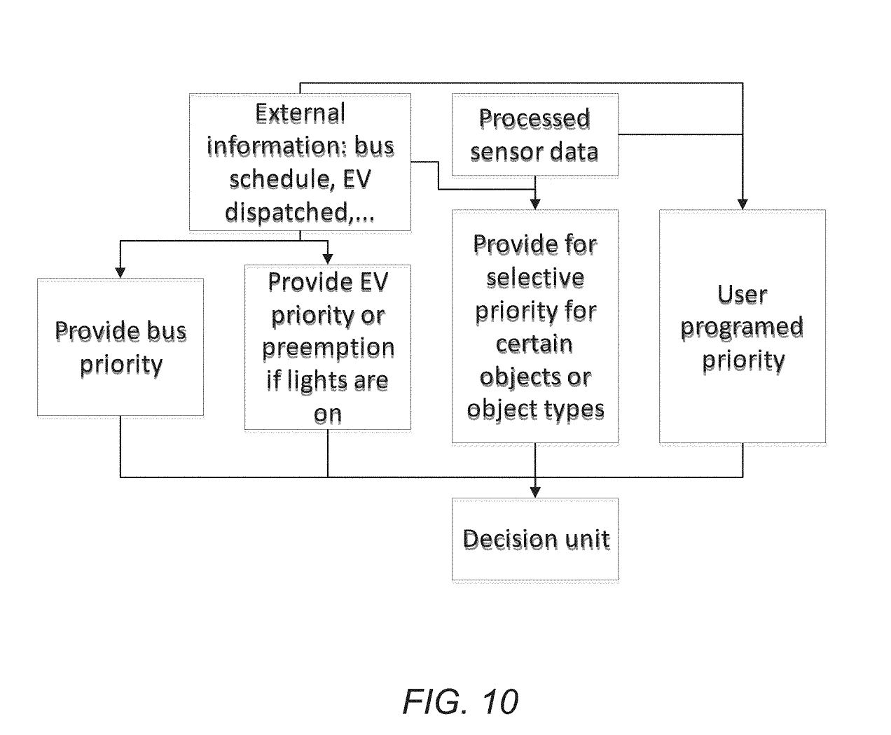

Because every car is tracked in many embodiments, emergency vehicle locations are known ahead of time, making Emergency Vehicle preemption (EVP) faster and more robust. Information on the transit time for different routes can be provided to emergency vehicles for better routing. A similar technique can be used with buses since they are also tracked between lights. As shown in FIG. 10, lights can give buses priority if they are behind schedule, or they can be programmed to always give buses priority. Selective priority can also be given to any other vehicle or vehicle class if desired. For example, pedestrians, bikes, or high occupancy vehicles could be weighted more strongly in an optimization process.

Emergency Vehicle preemption can be achieved by identifying emergency vehicles approaching a light from video footage. When the emergency lights of the vehicle are on, the vehicle can be identified via the periodicity of the flashing lights, by a unique spatial frequency between on and off lights, and by the intensity of certain colors for given pixels (such as red and blue). This could be achieved, for instance, by co-registering sequential frames of each vehicle onto a common grid (per vehicle), allowing for easier analysis of the time characteristics of strobing lights, as the same co-registered pixel should consistently map to the same physical location on the EV. Performing a Fourier Transform on each pixel in time and searching in frequency for powerful square waves (or similar periodic pulse-like waveforms) is one efficient manner of detecting these EV strobing lights. This applies because the frequency-domain power of a noiseless pulse train exists only in integer multiples of the pulse frequency. This is complicated by aliasing due to a finite sample rate, as well as the unknown pulse phase and width, almost certainly requiring an incoherent sum in power on the estimated fundamental frequency, as well as integer multiples of that frequency. Since noise is additive (and assumed Gaussian), this approaches a statistically efficient estimate of the pulse train's power given the available priors. Further, the strongest harmonic sum could be taken as a “pulsing light frequency candidate”—the ratio between this total power and the total power in the pixel's Power Spectral Density (PSD) could be used as a measure for the likelihood that a pixel represents a pulsing EV light. In some embodiments, the “harmonic sum” could, in fact, treat the fundamental frequency of each frequency candidate specially, for instance by multiplying its value with the harmonic sum of the rest of the harmonics, by requiring that its power is no less than some fraction of the total power found elsewhere in the spectrum, or by requiring that its power be above a threshold power level. This variant has value because many classes of pulse train waveforms will always have power in their fundamental frequency. In some embodiments, only pixels with sufficient total power would be considered, and by restricting this search to those frequencies known to be common for EVs (especially 75-150 pulses per minute), the sensitivity of detection could be enhanced. An alternative approach, if vehicle position estimation is insufficiently accurate to permit consistent co-registration of vehicle image frames, would be to compute the power and centroid of each image channel's position within the frame region of the vehicle. In some embodiments, the “registration” and “full image” techniques would be used in tandem, which provides (amongst other things) robustness against poorly-detected or poorly-tracked EVs. The aforementioned Harmonic Sum measures could be applied to these statistics as well, but the detection sensitivity would be substantially reduced. In either case, validation of flashing pixels may be applied by searching for blobs of common colors—valid lights are likely to show clusters of similar color. If the colors do not match the industry/government standard EV lights (within a variability tolerance) then that pixel region may be rejected for the purposes of EV detection. Harmonic sums or similar techniques can also be concatenated onto a regular feature descriptor comprising the LUV color space, Histogram of Oriented Gradients, Gradient Magnitude, Optical Flow, Feature Tracking and other statistics (any of which may be optionally filtered for orthogonality, and/or spatially averaged). As with object detection, these features can be used to detect objects which are utilizing emergency vehicle lights. Audio can be used to complement the visual features to enhance detection accuracy. Specifically, an audio detection (for instance, using a set of matched filters, or fitting a chirp function) can trigger a reduction in detection threshold for the visual detection system. Acoustic detections can also be performed using machine-learned techniques. Features could include time-variant mel-scale power averages in frequency, time-variant power averages in a chromatic scale (such as the popular musical 12-note scale), and/or features learned with a neural network or convolutional neural network. These features can be used to perform classifications, using techniques such as neural networks, SVMs random forests and/or other machine-learning techniques. Acoustic reflections are often very powerful, likely preventing sound from being a singular detection for EVs, but the relative sound of appropriately directional microphones on each approach may be used to get a measure of the likely direction of approach of an EV.

All techniques which are used for the detection of emergency vehicle lights can also be used in the detection of turning signals—with appropriate adjustments to pulse frequency, light placement and/or light color.

Like all other information gathered by the traffic control system in accordance with various embodiments of the invention, EV presence information can be shared across the network, preparing adjacent intersections for the potentially-oncoming EV before that EV gets within range of their detection zone. While specific processes for detecting EVs are described above with reference to FIG. 10, any of a variety of techniques can be utilized to detect and track emergency vehicles and/or supplement detection and/or tracking of emergency vehicles as appropriate to the requirements of a given application in accordance with various embodiments of the invention including (but not limited to) obtaining information concerning EV location from an EV fleet management system. Additional processes that can be utilized to improve public safety in accordance with various embodiments of the invention are discussed below.

### Emergency Vehicle Preemption

As discussed before, Emergency Vehicles (EV) can be detected through the use of some combination of acoustic and visual features—typical acoustic features could include time-variant mel-frequency power averages, chromatic power averages, chromatic shifts, and possibly neural-network features trained on top of any of combination of those. Visual features could include pixel magnitudes, gradient magnitudes, gradient orientation, and a measure of pixel-wise variability in the image. Ideally, the pixel-wise variability will be performed on a sequence of frames which have been registered to that vehicles' visual location in the image. Furthermore, the EV could have been detected from another system using optical/visual clues (and optionally, that detection could be communicated to the current system, via wireless or wired signal), detected through the use of some active communication device such as optical, infrared, radio or other. The EV could finally have been detected through some network-connected device which communicates through Bluetooth, WI-FI, or the internet, optionally reporting its light status, position (as inferred from a GIS system or otherwise) and/or origin/destination.

Suppose that an emergency vehicle has been detected via one of those techniques. It is desirable to respond to the emergency vehicle intelligently, for instance by providing all approaches with a red light, with the exception of the one servicing the emergency vehicle. A naive technique for this would be to simply suppress any optimization algorithms in the event of an emergency vehicles' approach. This would disrupt traffic flow, but would provide the emergency vehicle its required priority. If the traffic optimization algorithm involves optimizing some cost function, simply assigning a large (or even nearly infinite) positive cost to the emergency vehicles' delay would be sufficient to give it priority. This could be achieved by penalizing its presence in the road network, its presence when combined with red lights on its approach or others. In general, this class of technique will result in a system which better prepares for the event of the EV's arrival, by tidying up high-cost events earlier. This optimization will perform better, of course, the more forewarning that the intersection has, up to a limit of about one minute (a substantial portion of a typical light cycle). It is important to configure any optimization constraints such that the optimizer does not avoid servicing the EV in some way by simply never permitting it to enter some segments of the road network (this is especially a concern for distributed optimization systems). For redundancy purposes, many embodiments of this system would drive the emergency vehicle preemption signals to the controller upon a local detection anyways, to ensure that no optimization errors can cause the system to fail to service the emergency vehicle. As can readily be appreciated, the specific preemption process utilized within a traffic optimization system is largely dependent upon the requirements of a given application.

### Improving Traffic Safety

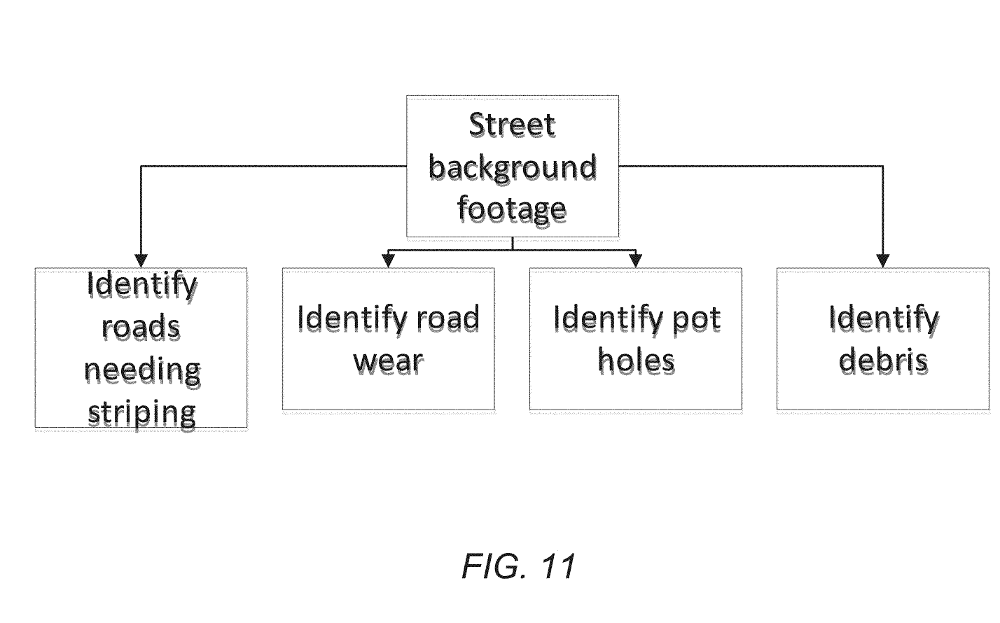

There are also several features which can be extracted from the surroundings which can help improve traffic safety. These features are highlighted in FIG. 11. A background model of the surroundings can be automatically generated in many motion detection algorithms. Using this background model, features such as road wear, locations of potholes, fading lane markings, and/or accumulating debris or obstructions in the roadway can be identified. The background image also gives insight into the current road visibility conditions such as sun glare and/or fog/smog, and provides a method for determining whether the road is wet, snowy, and/or icy.

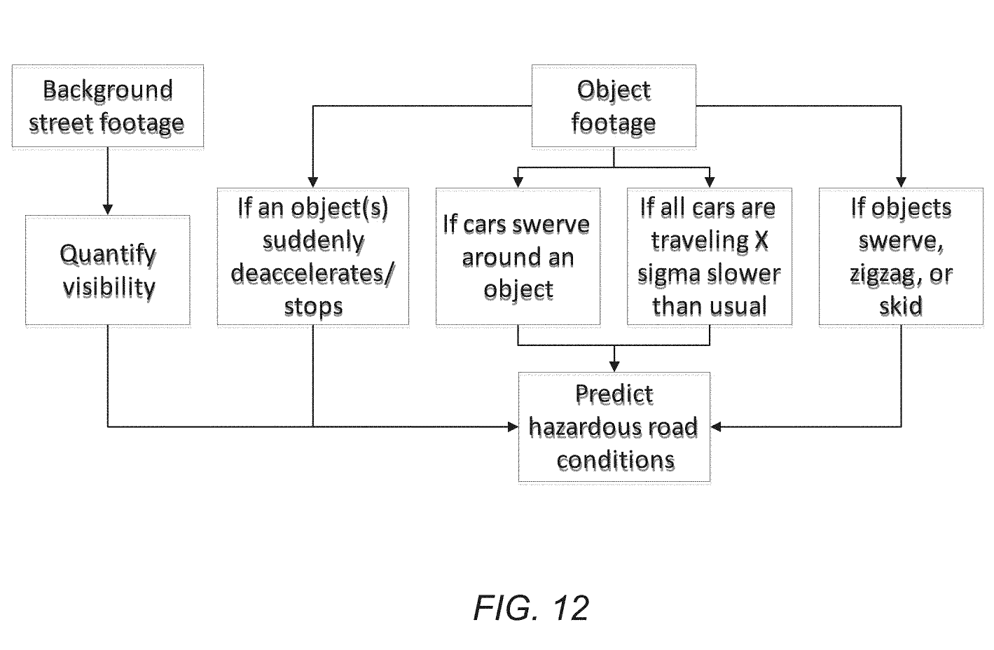

Another method for determining potentially hazardous road conditions is detailed in FIG. 12. In this case, the object footage rather than the background is used to assess road conditions. When vehicles hit a patch of ice or snow, they may slide, skid, or veer off the normal path vehicles take. The normal path vehicles take can be determined by looking at the statistics of vehicles which pass through the observed region. In many embodiments, outlier rejection can be utilized such as a median filter, or unsupervised learning techniques such as k-means or Expectation Maximization to model characteristic vehicle behaviors. Deviations from these characteristic vehicle behaviors may indicate traffic/road hazards such as obstructions to the flow of traffic, slick road conditions, or sun glare at dusk/dawn.

Another possible example is if cars start to travel slower or faster than would be statistically predicted. Again, the exact cause of this unusual behavior would depend on the circumstances. If vehicles suddenly slow down or stop it might be an indication of an obstacle in the road, an approaching emergency vehicle (undercover enforcement vehicles are more difficult to detect), or a special event causing additional traffic.

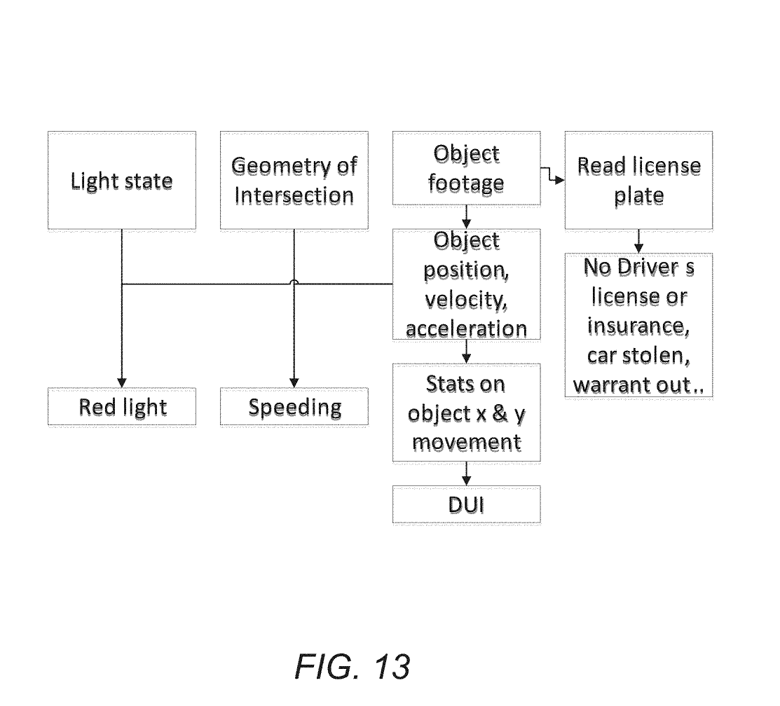

Similar techniques can be used to identify traffic violations as shown in FIG. 13. Red light violations can be detected by continued tracking of vehicles during the yellow and red phases of the light. Since video data has already been recorded and since the state of the traffic light is known it can be determined when a vehicle runs a red light using this system. Vehicle speed can be accurately estimated by tracking motion within the image (which has a one-to-one mapping to motion on the road). This allows for detection of vehicles exceeding the speed limit by some user-determined threshold, which may be adjusted in real-time. Detecting drivers who are driving under the influence or who may be distracted while driving can be determined by examining the reaction time of the drivers after presentation of a green light, their average speed compared to the mean for the traffic pattern, any lane wandering, and/or erratic behavior during driving. This can be determined using similar statistics about vehicle location, velocity and/or orientation as the vehicle moves through the intersection. If sufficiently high-resolution cameras are used, images of drivers' faces can be processed to enhance driver recognition and/or simplify prosecution of violations.

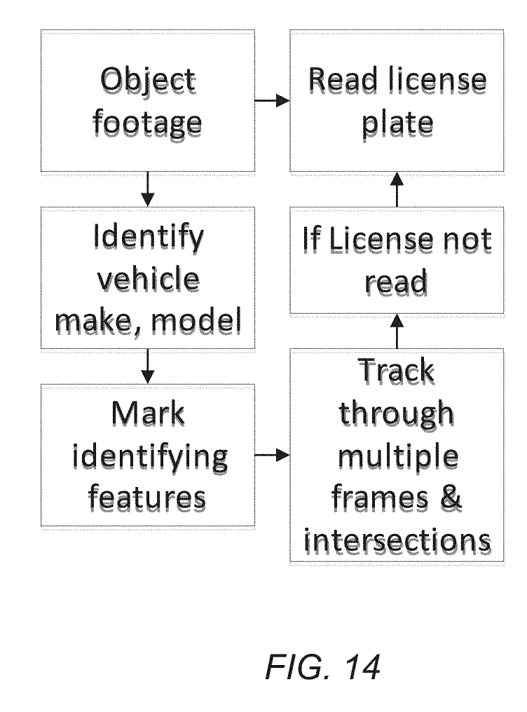

FIG. 14 shows a method for iteratively tracking cars and reading license plates to partially solve the issue of license plate occlusion. In several embodiments, systems form a mesh network of connected lights and each car's license plate may only need to be seen and read once. To achieve this it is necessary to track the car through multiple frames, which can be done even with partial occlusion and/or at low resolution. By identifying key features of each car such as its color, make, and/or any distinguishing external features such as dents or surface sheen one can distinguish it from similar cars. Since the location of the vehicle, its speed, and its route out of the intersection are known, the approximate arrival time at the next intersection can be estimated. When the car appears at the next intersection it can be matched to the features of the car described at the previous light. If the features match, it can be said that the cars identified at both intersections are the same car with high probability. If the license plate is successfully recognized at a connected intersection, that identification can be applied to the same vehicle seen in previous and future intersections. If camera footage is insufficient to resolve the plate from a single frame image, statistical techniques such as image stacking with optional transformation operations to properly align frames can be used over multiple frames and/or multiple intersections to synthesize a higher quality image of the license plate. Alternatively, super-resolution techniques can help detection of license plates, as the vehicle motion produces the required sampling diversity.

Parked vehicle detection can be accomplished by identifying which vehicles are parked at certain locations, which parking spots are available, and how long each spot is in use. The method is best used at connected intersections when the total number of cars into and out of a street can be monitored. Vehicles which park can be tracked and the time parked can be monitored. Information on which parking spaces are occupied can be used and communicated to drivers using any number of methods. If the street is completely enclosed, available roadside parking can be accurately estimated by counting the number of cars which enter the street but do not exit at the next intersection. If cameras can see half way to the next intersection then parking availability can be estimated in real time.

### License Plate Detection

If a car passes a light on red, the license plate of the car may be recorded and sent to the local jurisdiction. Because it is often difficult to see the license plate from the front of the car due to shadowing, the license plate may be recorded by all cameras capable of viewing the vehicle.

If a car's velocity exceeds the speed limit by a user-defined (potentially time-variable) threshold, the license plate of the car may be recorded and sent to the appropriate jurisdiction for ticketing. This does not require that the camera be mounted on a light.

If an accident occurs in the intersection, live data can be recorded and sent to emergency responders in real time as well as to the local jurisdiction. One method for estimating when an accident has occurred is to monitor the intersection for sudden deceleration and shape deformation of one or more vehicles.

While numerous traffic control systems and methods have been described above, the described techniques are applicable in a variety of applications including (but not limited to automated tolling without (or supplementing) smart passes, traffic backup for on ramps, car counting, statistics for city planning, object speed measurement, and/or pollution statistics generation. Further, although the present invention has been described in certain specific aspects, many additional modifications and variations would be apparent to those skilled in the art. In particular, any of the various processes described above can be performed in alternative sequences in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive.

What is claimed is:

1. A traffic optimization system, comprising:
at least one image sensor mounted with a bird's eye view of an intersection;
memory containing a traffic optimization application and classifier parameters for a plurality of classifiers, where each classifier is configured to detect a different class of object;
a processing system;
a traffic controller interface;
wherein the traffic optimization application directs the processing system to:
capture image data using the at least one image sensor;
search for pedestrians and vehicles visible within the captured image data by performing a plurality of classification processes based upon the classifier parameters for each of the plurality of classifiers;
retrieve traffic signal phasing information via the traffic controller interface;
determine modifications to the traffic signal phasing based upon detection of at least one of a pedestrian or a vehicle; and
send traffic signal phasing instructions to the traffic controller directing modification to the traffic signal phasing.

2. The traffic optimization system of claim 1, further comprising a network interface.

3. The traffic optimization system of claim 2, wherein the traffic optimization application directs the processor to retrieve information concerning vehicles approaching an intersection via the network interface and to utilize the information to determine modifications to the traffic signal phasing.

4. The traffic optimization system of claim 3, wherein the traffic optimization application directs the processor to retrieve information concerning vehicles approaching an intersection via the network interface from at least one service selected from the group consisting of:
a traffic control server system;
a public transit fleet management system;
a second traffic optimization system;
an emergency service fleet management system; and
a navigation service server system.

5. The traffic optimization system of claim 1, wherein the traffic optimization application directs the processing system to search for objects visible within the captured image data by performing a plurality of classification processes based upon the classifier parameters for each of the plurality of classifiers in which a determination is made whether to search for objects in a particular pixel location within the captured image data based upon an image prior.

6. The traffic optimization system of claim 5, wherein the image prior is automatically determined based upon a reference image containing a known real-world location of at least one background object visible in the captured image data.

7. The traffic optimization system of claim 5, wherein:
the image prior specifies a minimum size for a particular pixel location within the captured image data; and
the traffic optimization application directs the processing system to constrain the search for objects visible within the captured image data at the particular pixel location to objects of the minimum size.

8. The traffic optimization system of claim 5, wherein:
the image prior specifies a maximum size for a particular pixel location within the captured image data; and
the traffic optimization application directs the processing system to constrain the search for objects visible within the captured image data at the particular pixel location to objects of below the maximum size.

9. The traffic optimization system of claim 5, wherein:
the image prior specifies a minimum size and a maximum size for a particular pixel location within the captured image data; and
the traffic optimization application directs the processing system to constrain the search for objects visible within the captured image data at the particular pixel location to objects having a size between the minimum size and the maximum size.

10. The traffic optimization system of claim 1, wherein:
the processing system comprises at least one CPU and at least one GPU; and
the traffic optimization application directs the processing system to search for objects visible within the captured image data by performing a plurality of classification processes based upon the classifier parameters for each of the plurality of classifiers by:
directing the GPU to detect features within the captured image data; and
directing the CPU to detect objects based upon features generated by the GPU.

11. The traffic optimization system of claim 10, wherein:
at least one of the plurality of classification processes utilizes a random forest classifier that detects objects based upon features detected by the GPU; and
the traffic optimization application directs the CPU to terminate a process that utilizes a random forest classifier with respect to a specific pixel location within the captured image data when a specific early termination criterion is satisfied.

12. The traffic optimization system of claim 11, wherein:
the CPU comprises multiple processing cores; and
the traffic optimization application directs the processing system to execute each of the plurality of classification processes on a separate processing core.

13. The traffic optimization system of claim 1, wherein the at least one image sensor comprises an image sensor that captures color image data.

14. The traffic optimization system of claim 13, wherein the at least one image sensor further comprises an image sensor that captures near-infrared image data.

15. The traffic optimization system of claim 1, wherein the at least one image sensor comprises a near-infrared image sensor that captures near-infrared image data.

16. The traffic optimization system of claim 1, wherein the at least one image sensor comprises at least two image sensors that form a multiview stereo camera array that capture images of a scene from different viewpoints.

17. The traffic optimization system of claim 1, wherein the traffic optimization application directs the processing system to generate depth information by measuring disparity observed between image data captured by cameras in the multiview stereo camera array.

18. The traffic optimization system of claim 1, further comprising at least one sensor selected from the group consisting of a radar, a microphone, a microphone array, a depth sensor, and a magnetic loop sensor, fiber optic vibration sensors, and LIDAR systems.

19. A traffic optimization system, comprising:
a plurality of image sensors each mounted with a bird's eye view of an intersection, wherein the plurality of image sensors comprises:
a camera capable of capturing color image data; and
a near-infrared image sensor that captures near-infrared image data;
at least one microphone that captures audio data;
memory containing a traffic optimization application and classifier parameters for a plurality of classifiers, where each classifier is configured to detect a different class of object;
a processing system;
a traffic controller interface;
a network interface;
wherein the traffic optimization application directs the processing system to:
capture image data using the plurality of image sensors and audio data using the at least one microphone;
search for pedestrians and vehicles visible within the captured image data by performing a plurality of classification processes based upon the classifier parameters for each of the plurality of classifiers;
detect the presence of emergency vehicles based upon the captured audio data by performing a classification process based upon classifier parameters for an emergency vehicle classifier;
retrieve traffic signal phasing information via the traffic controller interface;
determine modifications to the traffic signal phasing based upon detection of at least one of a pedestrian, a vehicle, or an emergency vehicle;
send traffic signal phasing instructions to the traffic controller directing modification to the traffic signal phasing; and
send information describing detection of at least one of a pedestrian, a vehicle, or an emergency vehicle to a remote traffic control server via the network interface.

20. A traffic control system, comprising:
a plurality of traffic optimization systems, where at least one of the traffic optimization systems comprises:
at least one image sensor mounted with a bird's eye view of an intersection;
memory containing a traffic optimization application and classifier parameters for a plurality of classifiers, where each classifier is configured to detect a different class of object;
a processing system;
a traffic controller interface;
a network interface;
wherein the traffic optimization application directs the processing system to:
capture image data using the at least one image sensor;
search for pedestrians and vehicles visible within the captured image data by performing a plurality of classification processes based upon the classifier parameters for each of the plurality of classifiers;
retrieve traffic signal phasing information via the traffic controller interface;
retrieve information concerning vehicles approaching an intersection via the network interface;
determine modifications to the traffic signal phasing based upon at least one factor selected from the group consisting of:
detection of a pedestrian;
detection of a vehicle; and
retrieved information concerning vehicles approaching the intersection;
send traffic signal phasing instructions to the traffic controller directing modification to the traffic signal phasing; and
send information describing detection of at least one of a pedestrian or a vehicle to a remote traffic control server system via the network interface;
wherein the traffic control server system comprises:
a network interface;
memory containing a traffic control server system application;
a processing system directed by the traffic control server system application to:
receive information describing detection of at least one of a pedestrian, or a vehicle from a traffic optimization system; and
transmit information concerning vehicles approaching a given intersection to a traffic optimization system.
